(19) United States
(12) Patent Application Publication
(10) Pub. No.: US 2025/0140806 A1
(43) Pub. Date: May 1, 2025

(54) METHOD FOR MANUFACTURING CATHODE ACTIVE MATERIAL FOR LITHIUM SECONDARY BATTERY, CATHODE ACTIVE MATERIAL FOR LITHIUM SECONDARY BATTERY, ELECTRODE, AND SOLID LITHIUM SECONDARY BATTERY

(71) Applicant: SUMITOMO CHEMICAL COMPANY, LIMITED, Tokyo (JP)

(72) Inventors: Haruka HOSOKAWA NIIDA, Niihama-shi (JP); Takuya KADOWAKI, Niihama-shi (JP); Yoji MATSUO, Niihama-shi (JP)

(21) Appl. No.: 18/835,128

(22) PCT Filed: Feb. 6, 2023
(86) PCT No.: PCT/JP2023/003710

§ 371 Date: Aug. 1, 2024

(30) Foreign Application Priority Data
Feb. 8, 2022 (JP) 2022-018060

(51) Int. Cl. H01M 4/36; H01M 4/02; H01M 4/04; H01M 4/525; H01M 10/0525; H01M 10/0562

(52) U.S. Cl. CPC H01M 4/366; H01M 4/04; H01M 4/525; H01M 10/0525; H01M 2004/021; H01M 10/0562; H01M 2300/0068

(57) ABSTRACT

A method for manufacturing a cathode active material for lithium secondary battery is provided, which includes a lithium metal composite oxide and a coating layer coating at least a part of one particle of the lithium metal composite oxide, the method including a coating step of bringing the lithium metal composite oxide into contact with a coating liquid for forming the coating layer using a coating device provided with a two-fluid nozzle, in which the lithium metal composite oxide satisfies (A), the coating step includes spraying each of the coating liquid and high-pressure airflow from the coating device, and the high-pressure airflow satisfies (B).

### TECHNICAL FIELD

The present invention relates to a method for manufacturing a cathode active material for lithium secondary battery, a cathode active material for lithium secondary battery, an electrode, and a solid lithium secondary battery.

Priority is claimed on Japanese Patent Application No. 2022-018060, filed on Feb. 8, 2022, the content of which is incorporated herein by reference.

### BACKGROUND ART

As the lithium secondary battery, a configuration including a cathode having a cathode active material, an anode, and an electrolyte in contact with the cathode and the anode is known.

As the electrolyte used in the lithium secondary battery, an electrolytic solution containing an organic solvent or a solid electrolyte is known. In the following description, the electrolytic solution and the solid electrolyte may be collectively referred to as “electrolyte”.

At an interface between the cathode and the electrolyte, the cathode active material included in the cathode and the electrolyte are in contact with each other. In the lithium secondary battery, insertion of Li ions from the electrolyte into the cathode active material and extraction of Li ions from the cathode active material into the electrolyte are performed according to charging and discharging of the battery.

There is an attempt to improve the performance of the lithium secondary battery by focusing on an interface between the cathode and the electrolyte. For example, Patent Document 1 discloses a method for manufacturing a cathode active material for lithium-ion secondary battery, in which an alumina coating layer is formed on a particle surface of a lithium cobalt composite oxide.

### CITATION LIST

### Patent Document

### [Patent Document 1]

Japanese Unexamined Patent Application, First Publication No. 2005-276454

### SUMMARY OF INVENTION

### Technical Problem

For example, in a case where a coating layer is provided on a surface of lithium metal composite oxide particles, a method of adding a coating raw material by spraying to the lithium metal composite oxide is known as disclosed in Patent Document 1.

In the study of coating a surface of the lithium metal composite oxide with high coverage, the present inventors have faced a problem in that the lithium metal composite oxide becomes chipped and fine particles are generated in a manufacturing process including a coating step. The fine particles herein refer to fine particles having a very small diameter, and refer to particles which cannot be in contact with the surrounding lithium metal composite oxide. The diameter of such fine particles is, for example, 0.5 μm or less, or even below submicron. Hereinafter, the phenomenon in which the lithium metal composite oxide becomes chipped and fine particles are generated may be referred to as “chipping”.

In a case where a network of electron conduction and ion conduction is sufficiently constructed between particles of the cathode active material, the battery performance is easily improved.

However, the fine particles generated by chipping are present as a component which does not contribute to charging and discharging, without forming the network of electron conduction and ion conduction.

The present invention has been made in view of the above circumstances, and an object of the present invention is to provide a method for manufacturing a cathode active material for lithium secondary battery, including a coating layer, in which coverage is high and generation of fine particles is small; a cathode active material for lithium secondary battery; an electrode; and a solid lithium secondary battery.

In the present specification, the “coverage is high” means that the coverage measured by a method described in [Method for measuring surface presence rate of element A] later is 70% or more.

In the present specification, the “fine particles are small” means that, in a volume-based cumulative particle size distribution curve of the cathode active material for lithium secondary battery, which is obtained by a wet particle size distribution measurement using a laser diffraction type particle size distribution analyzer, a value of (WD₅₀−WDₘᵢₙ)/WD₅₀ is 0.6 or less. Here, in the cumulative particle size distribution curve obtained by the wet particle size distribution measurement, a particle diameter at which a cumulative proportion from the small particle side is 50% is defined as WD₅₀ (μm), and the minimum particle diameter in the cumulative particle size distribution curve is defined as WDₘᵢₙ (μm).

### Solution to Problem

The present invention includes the following [1] to [16].

[1] A method for manufacturing a cathode active material for lithium secondary battery, which includes a lithium metal composite oxide and a coating layer coating at least a part of one particle of the lithium metal composite oxide, the method including:
a coating step of bringing the lithium metal composite oxide into contact with a coating liquid for forming the coating layer using a coating device provided with a two-fluid nozzle,
in which the lithium metal composite oxide satisfies the following (A),
the coating step is a step of spraying each of the coating liquid and high-pressure airflow from the two-fluid nozzle, and
the high-pressure airflow satisfies the following (B),

$${A}_{0.4} / {A}_{0.1} < 1.9 , \qquad ( A )$$

[in a volume-based cumulative particle size distribution of the lithium metal composite oxide, which is obtained by a dry particle size distribution measurement using a laser diffraction type particle size distribution analyzer, A_{0.4} is a value of (D₉₀−D₁₀)/D₅₀ in a case of measuring with a dispersion air pressure of 0.4 MPa and A_{0.1} is a value of (D₉₀−D₁₀)/D₅₀ in a case of measuring with a dispersion air pressure of 0.1 MPa,
in the cumulative particle size distribution, a particle diameter at which a cumulative proportion from a small particle side is 10%, 50%, or 90% is defined as D₁₀, D₅₀, or D₉₀], and

$$0.002 < {E}_{2} \leq 0.550 , \qquad ( B )$$

[here, E₂ (W/g) is expansion energy of the high-pressure airflow per unit mass of the lithium metal composite oxide, and expansion energy E₁ (W) generated in a case where the high-pressure airflow is released to atmospheric pressure is calculated by the following expression,

$${E}_{1} = n R T \times ln ( {P}_{1} / {P}_{2} )$$

(n=a number of moles (mol) of the high-pressure airflow, R=a gas constant, T=298.15 (K), P₁=a pressure (MPaA) of the high-pressure airflow, P₂=the atmospheric pressure (MPaA))].

[2] The method for manufacturing a cathode active material for lithium secondary battery according to [1],
in which the coating layer is an oxide containing an element A, and
the element A is one or more selected from the group consisting of Nb, Ta, Ti, Al, B, P, W, Zr, La, and Ge.

[3] The method for manufacturing a cathode active material for lithium secondary battery according to [1] or [2],
in which the lithium metal composite oxide satisfies the following formula (I),

Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W B, P, Mo, Zn, Sn, Zr, Ga, La, Ti, Ta, Nb, and V, and −0.10≤x≤0.3, 0≤y≤0.40, 0≤z≤0.40, 0≤w≤0.10, and y+z+w<1 are satisfied)

[4] The method for manufacturing a cathode active material for lithium secondary battery according to any one of [1] to [3],
in which the lithium metal composite oxide contains secondary particles which are an aggregate of primary particles.

[5] The method for manufacturing a cathode active material for lithium secondary battery according to any one of [1] to [4], further including, after the coating step:
a heat treatment step of performing heating at a temperature of 100° C. or higher and 500° C. or lower.

[6] The method for manufacturing a cathode active material for lithium secondary battery according to any one of [1] to [5],
in which, in the lithium metal composite oxide, a cumulative frequency (%) in a range from a minimum value of a particle diameter in a particle size distribution curve (0.4) of the cumulative particle size distribution in the case of measuring with a dispersion air pressure of 0.4 MPa to a minimum value of a particle diameter in the cumulative particle size distribution obtained in a case of measuring with a dispersion air pressure of 0.1 MPa is 28% or less.

[7] The method for manufacturing a cathode active material for lithium secondary battery according to any one of [1] to [6],
in which, in a scatter diagram of the lithium metal composite oxide, in which the dispersion air pressure (MPa) is used as a horizontal axis and D₁₀ (μm) is used as a vertical axis, an absolute value of a slope of a straight line, obtained by connecting a point at which the dispersion air pressure is 0.4 MPa and a point at which the dispersion air pressure is 0.1 MPa, is 19 or less.

[8] The method for manufacturing a cathode active material for lithium secondary battery according to any one of [1] to [7],
in which the coating step is a step of performing the coating using a roll-to-roll flow coating device.

[9] The method for manufacturing a cathode active material for lithium secondary battery according to any one of [1] to [8],
in which the cathode active material for lithium secondary battery is a cathode active material for solid lithium secondary battery.

[10] A cathode active material for lithium secondary battery, including:
a lithium metal composite oxide; and
a coating layer which coats at least a part of one particle of the lithium metal composite oxide,
in which the coating layer is an oxide containing an element A,
the element A is one or more selected from the group consisting of Nb, Ta, Ti, Al, B, P, W, Zr, La, and Ge, and
the following (X) to (Z) are satisfied,
(X) coverage of the lithium metal composite oxide is 70% or more,

$$( {WD}_{50} - {WD}_{min} ) / {WD}_{50} \leq 0.6 , \qquad ( Y )$$

(in a volume-based cumulative particle size distribution curve obtained by a wet particle size distribution measurement using a laser diffraction type particle size distribution analyzer, a particle diameter (μm) at which a cumulative proportion from a small particle side is 50% is defined as WD₅₀, and a minimum particle diameter (μm) in the obtained cumulative particle size distribution curve is defined as WDₘᵢₙ), and

$${Z}_{0.4} / {Z}_{0.1} < 1.7 , \qquad ( Z )$$

(in a volume-based cumulative particle size distribution curve of the cathode active material for lithium secondary battery, which is obtained by a dry particle size distribution measurement using a laser diffraction type particle size distribution analyzer, Z_{0.4} is a value of (D₉₀−D₁₀)/D₅₀ in a case of measuring with a dispersion air pressure of 0.4 MPa and Z_{0.1} is a value of (D₉₀−D₁₀)/D₅₀ in a case of measuring with a dispersion air pressure of 0.1 MPa, in the cumulative particle size distribution curve, a particle diameter at which a cumulative proportion from a small particle side is 10%, 50%, or 90% is defined as D₁₀, D₅₀, or D₉₀).

[11] An electrode containing:
the cathode active material for lithium secondary battery according to [10].

[12] The electrode according to [11], further containing:
a solid electrolyte.

[13] A solid lithium secondary battery, including:
a cathode;
an anode; and
a solid electrolyte layer interposed between the cathode and the anode,
in which the solid electrolyte layer contains a first solid electrolyte,
the cathode includes a cathode active material layer in contact with the solid electrolyte layer, and a current collector on which the cathode active material layer is laminated, and
the cathode active material layer contains the cathode active material for lithium secondary battery according to [10].

[14] The solid lithium secondary battery according to [13],
in which the cathode active material layer contains the cathode active material for lithium secondary battery and a second solid electrolyte.

[15] The solid lithium secondary battery according to [14],
in which the first solid electrolyte and the second solid electrolyte are the same material.

[16] The solid lithium secondary battery according to any one of [13] to [15],
in which the first solid electrolyte is a sulfide solid electrolyte.

### Advantageous Effects of Invention

According to the present invention, it is possible to provide a method for manufacturing a cathode active material for lithium secondary battery, including a coating layer, in which coverage is high and generation of fine particles is small; a cathode active material for lithium secondary battery; an electrode; and a solid lithium secondary battery.

### BRIEF DESCRIPTION OF DRAWINGS

FIG. 1 is a schematic view showing an example of a lithium secondary battery.

FIG. 2 is a schematic view showing an example of a solid lithium secondary battery.

FIG. 3 is a schematic diagram showing an example of a cumulative particle size distribution curve.

FIG. 4 is a schematic diagram showing an example of a cumulative particle size distribution curve.

FIG. 5 is a schematic diagram showing an example of a slope at a predetermined coordinate.

### DESCRIPTION OF EMBODIMENTS

### <Method for Manufacturing Cathode Active Material for Lithium Secondary Battery>

The present embodiment is a method for manufacturing a cathode active material for lithium secondary battery, which includes a lithium metal composite oxide and a coating layer coating at least a part of one particle of the lithium metal composite oxide.

In the present specification, a metal composite compound will be referred to as “MCC”.

In the present specification, a lithium metal composite oxide will be referred to as “LiMO”.

A cathode active material for lithium secondary battery will be referred to as “CAM”.

The notation “Li” does not indicate a Li metal element, but a Li element, unless particularly otherwise specified. The same applies to notations of other elements such as Ni, Co, and Mn.

In a case where a numerical range is described as, for example, “1 to 10 μm”, the numerical range means a range from 1 μm to 10 μm, and means a numerical range including 1 μm as a lower limit value and 10 μm as an upper limit value.

The method for manufacturing the CAM according to the present embodiment includes a step of manufacturing the LiMO and a coating step.

### Step of Manufacturing LiMO>>

In this step, LiMO satisfying the following (A) is manufactured.

$${A}_{0.4} / {A}_{0.1} < 1.9 \qquad ( A )$$

[in a volume-based cumulative particle size distribution of the LiMO, which is obtained by a dry particle size distribution measurement using a laser diffraction type particle size distribution analyzer, A_{0.4} is a value of (D₉₀−D₁₀)/D₅₀ in a case of measuring with a dispersion air pressure of 0.4 MPa and A_{0.1} is a value of (D₉₀−D₁₀)/D₅₀ in a case of measuring with a dispersion air pressure of 0.1 MPa, in the cumulative particle size distribution, a particle diameter at which a cumulative proportion from a small particle side is 10%, 50%, or 90% is defined as D₁₀, D₅₀, or D₉₀]

### [Dry Particle Size Distribution Measurement]

From the dry particle size distribution measurement using a laser diffraction type particle size distribution analyzer, the volume-based cumulative particle size distribution curve of the LiMO is obtained. The dry particle size distribution is measured using a jet type dry measurement device. The jet type dry measurement device is a measuring method by spraying the LiMO which is a measurement target from a nozzle using compressed air and forcibly dispersing the LiMO in the air so as to pass through a laser beam.

Specifically, first, a volume-based cumulative particle size distribution curve is obtained by measuring a dry particle size distribution of 2 g of a powder of the LiMO using a laser diffraction particle size distribution analyzer at a predetermined compressed air pressure. In the obtained cumulative particle size distribution curve, from a small particle side, a particle diameter at a cumulative proportion of 10%, a particle diameter at a cumulative proportion of 50%, and a particle diameter at a cumulative proportion of 90% are defined as D₁₀ (μm), D₅₀ (μm), and D₉₀ (μm), respectively.

As the laser diffraction particle size distribution analyzer, for example, MS2000 manufactured by Malvern Panalytical Ltd. can be used. In the present embodiment, the measurement is performed with a compressed air pressure of 0.4 MPa and with a compressed air pressure of 0.1 MPa.

From each of the values of D₁₀ (μm), D₅₀ (μm), and D₉₀ (μm) obtained in the measurement with a compressed air pressure of 0.4 MPa, (D₉₀−D₁₀)/D₅₀ is calculated, and defined as A_{0.4}.

From each of the values of D₁₀ (μm), D₅₀ (μm), and D₉₀ (μm) obtained in the measurement with a compressed air pressure of 0.1 MPa, (D₉₀−D₁₀)/D₅₀ is calculated, and defined as A_{0.1}.

A_{0.4}/A_{0.1}, which is a ratio of A_{0.4} to A_{0.}, is calculated.

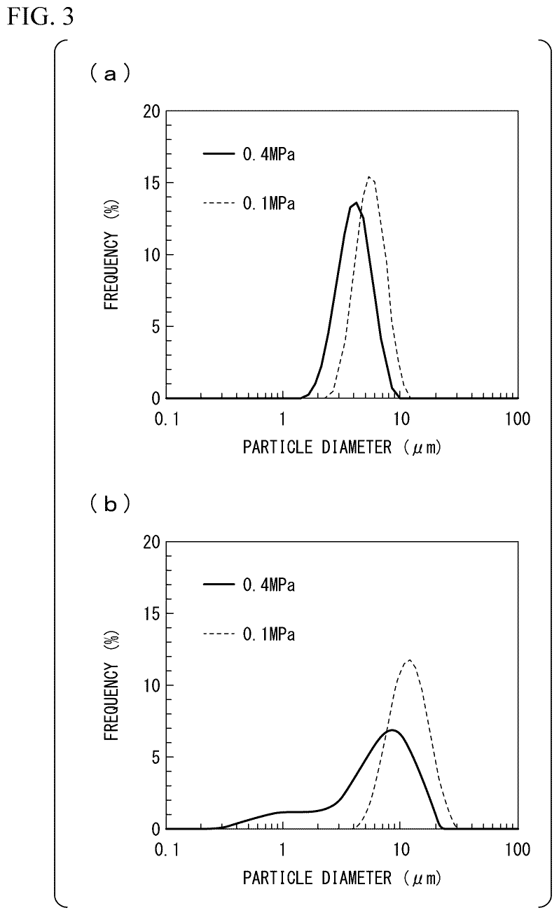

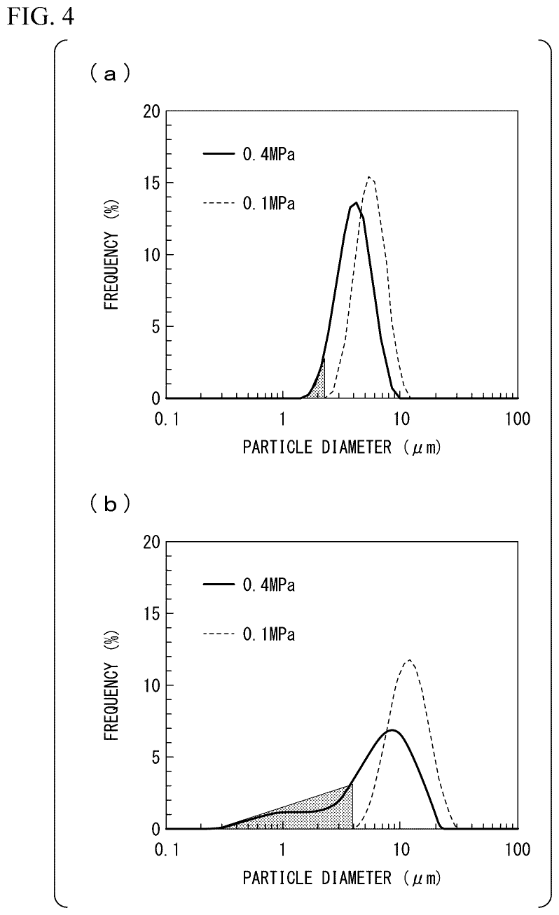

FIG. 3(a) shows cumulative particle size distribution curves of the LiMO satisfying (A) in a case of measuring with a dispersion air pressure 0.4 MPa and 0.1 MPa. In the cumulative particle size distribution curves shown in FIG. 3(a), A_{0.4}/A_{0.1} is 1.14. Even in a case where the dispersion air pressure is increased from 0.1 MPa to 0.4 MPa, the shape of the cumulative particle size distribution curve of the LiMO satisfying (A) is not significantly changed. This means that chipping is less likely to occur even in a case where high-pressure air is blown.

FIG. 3(b) shows cumulative particle size distribution curves of the LiMO in which the value of A_{0.4}/A_{0.1} is 1.9 or more, in a case of measuring with a dispersion air pressure 0.4 MPa and 0.1 MPa. In the cumulative particle size distribution curves shown in FIG. 3(b), A_{0.4}/A_{0.1} is 1.9. From FIG. 3(b), in a case where the dispersion air pressure is increased to a high pressure of 0.4 MPa from 0.1 MPa, the shape of the cumulative particle size distribution curve is significantly changed. This means that chipping is likely to occur by blowing the high-pressure air.
(A) is preferably any one of the following (A)-1 to (A)-3.

$$0.3 \leq {A}_{0.4} / {A}_{0.1} < 1.9 \qquad ( A ) - 1$$

$$0.5 \leq {A}_{0.4} / {A}_{0.1} < 1.6 \qquad ( A ) - 2$$

$$0.7 \leq {A}_{0.4} / {A}_{0.1} < 1.3 \qquad ( A ) - 3$$

The LiMO satisfying (A) is less likely to cause chipping. Therefore, in a case where the coating raw material is sprayed in the subsequent coating step, chipping is less likely to occur.

Preferred composition and physical properties such as particle size distribution, which are preferably satisfied by the LiMO, will be described later.

Details of the method for manufacturing the LiMO will be described later.

### Coating Step>>

In order to coat at least a part of one particle of the LiMO, the coating liquid is brought into contact with the LiMO using a coating device provided with a two-fluid nozzle. Thereafter, a coating layer which coats at least a part of the LiMO can be formed by performing heat treatment as necessary.

The device provided with a two-fluid nozzle sprays the coating liquid as a first fluid from one nozzle and sprays high-pressure airflow as a second fluid from the other nozzle to blow the high-pressure airflow against the coating liquid. As a result, the coating liquid is sprayed together with the high-pressure airflow while being micro-atomized to a liquid droplet diameter equal to or smaller than the particle size of the coating target. In addition, since the dispersing effect of the coating target particles by the high-pressure airflow is also exhibited, it is easy to form a uniform coating layer on the surface of the coating target particles.

However, since the high-pressure airflow for the spraying collides with the LiMO, the occurrence of chipping of the LiMO is a problem. The LiMO satisfying (A) is less likely to cause chipping even in a case where the high-pressure airflow collides with the LiMO as described above.

The high-pressure airflow mixed with the coating liquid satisfies the following (B) in which E2 is expansion energy per unit weight of the LiMO.

$$0.002 < {E}_{2} \leq 0.55 \qquad ( B )$$

E₂ (W/g) is a value obtained by dividing expansion energy E1 (W) in a case where the high-pressure airflow is sprayed under atmospheric pressure, by the mass (g) of the LiMO.

Here, the mass of the LiMO is the amount of LiMO fed to the coating device.

The amount fed to the coating device is, for example, a fed amount per batch in a case of a batch type coating device. In a case of a continuous coating device, the fed amount is an amount obtained by multiplying a supply amount (unit: kg/hour) by a retention time (unit: time) in the coating device.

The expansion energy E₁ is calculated by the following expression.

$${E}_{1} = {\int }_{{V}_{1}}^{{V}_{2}} npdv = nRT ln \frac{{V}_{1}}{{V}_{2}} = nRT ln \frac{{P}_{1}}{{P}_{2}}$$

(n=the number of moles (mol) of the high-pressure airflow, R=the gas constant, T=298.15 (K), P₁=a pressure (MPaA) of the high-pressure airflow, P₂=the atmospheric pressure (MPaA))

In a case of calculating E₁, the gas constant R is set to 8.314 (J/(K mol)).

In a case of calculating E₁, variables are n and P₁. n is calculated from the type and the flow rate (g/min) of the high-pressure airflow.

As the high-pressure airflow, air, and air from which carbon dioxide has been removed are exemplary examples. In the present embodiment, it is preferable that the high-pressure airflow be air from which carbon dioxide has been removed.

The air flow rate of the high-pressure airflow is, for example, 10 to 70 NL/min.

The spraying pressure of the high-pressure airflow is, for example, 0.01 to 0.30 MPa.

(B) is preferably any one of the following (B)-1 to (B)-3.

$$0.01 < {E}_{2} \leq 0.5 \qquad ( B ) - 1$$

$$0.015 < {E}_{2} \leq 0.45 \qquad ( B ) - 2$$

$$0.02 < {E}_{2} \leq 0.4 \qquad ( B ) - 3$$

In a case where the LiMO is brought into contact with the high-pressure airflow containing the coating liquid under conditions satisfying (B), chipping is less likely to occur.

In the coating step, it is preferable to use a roll-to-roll flow coating device.

As the roll-to-roll flow coating device, for example, MP-01 manufactured by Powrex Corp. can be suitably used.

### [Heat Treatment Step]

It is preferable that the method further include a heat treatment step after the coating step.

In a case where the coating liquid and the LiMO are mixed and heat-treated, it is preferable to perform a heating step at a temperature of 100° C. to 500° C.

The CAM in which a coating layer with few impurities is formed on the surface of the LiMO is obtained by heat-treating a mixture of the coating material raw material and the LiMO under the above-described heat treatment conditions.

The CAM is appropriately crushed and classified to be a cathode active material for lithium secondary battery.

Hereinafter, an example of a method for manufacturing the LiMO will be described by dividing the method into a step of manufacturing the MCC and a step of manufacturing the LiMO.

### (Step of Manufacturing MCC)

In a case of manufacturing the LiMO, it is preferable that the MCC containing a metal other than lithium, which is a metal constituting the LiMO, be first prepared, and the MCC be calcined with an appropriate lithium compound.

Specifically, the “MCC” is a compound containing Ni, which is an essential metal, and any one or more metals selected from Co, Mn, Al, W, B, Mo, Zn, Sn, Zr, Ga, La, Ti, Nb, or V.

As the MCC, a metal composite hydroxide or a metal composite oxide is preferable.

The MCC can be manufactured by a generally known co-precipitation method. As the co-precipitation method, it is possible to use a commonly known batch co-precipitation method or a continuous co-precipitation method. Hereinafter, the method for manufacturing the MCC will be described in detail using, as a metal, a metal composite hydroxide containing Ni, Co, and Mn as an example.

First, a nickel salt solution, a cobalt salt solution, a manganese salt solution, and a complexing agent are reacted with one another by a co-precipitation method, particularly, a continuous co-precipitation method described in JP-A-2002-201028, thereby manufacturing a metal composite hydroxide represented by Ni_{(1-y-z)}Co_{y}Mn_{z}(OH)₂ (in the formula, y+z≤1).

A nickel salt which is a solute of the above-described nickel salt solution is not particularly limited, and, for example, one or more of nickel sulfate, nickel nitrate, nickel chloride, and nickel acetate can be used.

As a cobalt salt which is a solute of the above-described cobalt salt solution, for example, one or more of cobalt sulfate, cobalt nitrate, cobalt chloride, and cobalt acetate can be used.

As a manganese salt which is a solute of the above-described manganese salt solution, for example, one or more of manganese sulfate, manganese nitrate, manganese chloride, and manganese acetate can be used.

The above-described metal salt is used in a proportion corresponding to the above-described compositional ratio of Ni_{(1-y-z)}Co_{y}Mn_{z}(OH)₂. That is, the amount of each of the metal salts used is set so that the molar ratio of Ni in the solute of the nickel salt solution, Co in the solute of the cobalt salt solution, and Mn in the solute of the manganese salt solution is to be 1−y−z:y:z corresponding to the compositional ratio of Ni_{(1-y-z)}Co_{y}Mn_{z}(OH)₂.

In addition, a solvent of the nickel salt solution, the cobalt salt solution, and the manganese salt solution is water. That is, the solvent of the nickel salt solution, the cobalt salt solution, and the manganese salt solution is an aqueous solution.

The complexing agent is a compound capable of forming a complex with a nickel ion, a cobalt ion, and a manganese ion in an aqueous solution. As the complexing agent, for example, ammonium ion donors (ammonium salts such as ammonium hydroxide, ammonium sulfate, ammonium chloride, ammonium carbonate, and ammonium fluoride), hydrazine, ethylenediaminetetraacetic acid, nitrilotriacetic acid, uracildiacetic acid, and glycine are exemplary examples.

In a case of using the complexing agent, the amount of the complexing agent contained in the mixed solution containing the nickel salt solution, the optional metal salt solution, and the complexing agent is, for example, a molar ratio of more than 0 and 2.0 or less with respect to the total number of moles of the metal salt. In a case of using the complexing agent, the amount of the complexing agent contained in the mixed solution containing the nickel salt solution, the cobalt salt solution, the manganese salt solution, and the complexing agent is, for example, a molar ratio of more than 0 and 2.0 or less with respect to the total number of moles of the metal salt.

In the co-precipitation method, in order to adjust the pH value of the mixed solution containing the nickel salt solution, the optional metal salt solution, and the complexing agent, an alkali metal hydroxide is added to the mixed solution before the pH of the mixed solution changes from alkaline to neutral. The alkali metal hydroxide is, for example, sodium hydroxide or potassium hydroxide.

The pH value in the present specification is defined as a value measured in a case where the temperature of the mixed solution is 40° C. The pH of the mixed solution is measured in a case where the temperature of the mixed solution sampled from a reaction vessel reaches 40° C.

In a case where the complexing agent in addition to the nickel salt solution, the cobalt salt solution, and the manganese salt solution described above is continuously supplied to the reaction vessel, Ni, Co, and Mn react with each other to form Ni_{(1-y-z)}Co_{y}Mn_{z}(OH)₂.

During the reaction, the temperature of the reaction vessel is controlled, for example, within a range of 20° C. or higher and 80° C. or lower, preferably 30° C. to 70° C.

In addition, during the reaction, the pH value in the reaction vessel is controlled, for example, within a range of pH 9 to pH 13, preferably pH 11 to pH 13.

The substances in the reaction vessel are appropriately stirred and mixed together.

As the reaction vessel which is used in the continuous co-precipitation method, an overflow type reaction vessel can be used to separate the formed reaction precipitate.

By appropriately controlling the concentrations of the metal salts in the metal salt solutions supplied to the reaction vessel, the stirring speed, the reaction temperature, the reaction pH, calcining conditions described later, and the like, it is possible to control various physical properties of the LiMO which is finally obtained, such as a secondary particle diameter and a pore radius.

In addition to the control of the above-described conditions, an oxidation state of the obtained reaction product may be controlled by supplying a variety of gases, for example, an inert gas such as nitrogen, argon, or carbon dioxide, an oxidizing gas such as air or oxygen, or a gas mixture thereof to the reaction vessel.

As a compound (oxidizing agent) which oxidizes the obtained reaction product, it is possible to use peroxides such as hydrogen peroxide, peroxide salts such as permanganate, perchlorates, hypochlorites, nitric acid, halogens, ozone, or the like.

As a compound which reduces the obtained reaction product, it is possible to use organic acids such as oxalic acid and formic acid, sulfites, hydrazines, or the like.

In detail, the inside of the reaction vessel may be an inert atmosphere. In a case where the inside of the reaction vessel is an inert atmosphere, a metal which is more easily oxidized than Ni among the metals contained in the mixed solution is prevented from aggregating earlier than Ni. Therefore, a uniform metal composite hydroxide can be obtained.

In addition, the inside of the reaction vessel may be an appropriate oxidizing atmosphere. The oxidizing atmosphere may be an oxygen-containing atmosphere formed by mixing an oxidizing gas into an inert gas, and when the inside of the reaction vessel, in which an oxidizing agent may be present in an inert gas atmosphere, is an appropriate oxidizing atmosphere, a transition metal which is contained in the liquid mixture is appropriately oxidized, which makes it easy to control the form of the metal composite oxide.

As oxygen or the oxidizing agent in the oxidizing atmosphere, a sufficient number of oxygen atoms need to be present in order to oxidize the transition metal.

In a case where the oxidizing atmosphere is an oxygen-containing atmosphere, the atmosphere in the reaction vessel can be controlled by a method in which an oxidizing gas is bubbled or the like in the liquid mixture, which aerates the oxidizing gas into the reaction vessel.

After the above-described reaction, the obtained reaction precipitate is washed with water and dried, whereby the MCC is obtained. In the present embodiment, a nickel cobalt manganese hydroxide is obtained as the MCC. In addition, in a case where the reaction precipitate is washed with water only, and foreign matter derived from the mixed solution remains, the reaction precipitate may be washed with weak acid water or an alkaline solution, as necessary. As the alkaline solution, an aqueous solution containing sodium hydroxide or potassium hydroxide is an exemplary example.

In the above-described example, the nickel-cobalt-manganese composite hydroxide is manufactured, but a nickel-cobalt-manganese composite oxide may be prepared.

For example, the nickel-cobalt-manganese composite oxide can be prepared by oxidizing the nickel-cobalt-manganese composite hydroxide. Regarding the calcining time for oxidation, the total time taken while the temperature begins to be raised and reaches the calcining temperature and the holding of the composite metal hydroxide at the calcining temperature ends is preferably set to 1 to 30 hours.

The temperature rising rate in the heating step until the highest holding temperature is reached is preferably 180° C./hour or more, more preferably 200° C./hour or more, and particularly preferably 250° C./hour or more.

The highest holding temperature in the present specification is the highest holding temperature of the atmosphere in a calcining furnace in a calcining step and means the calcining temperature in the calcining step. In the case of a main calcining step having a plurality of heating steps, the highest holding temperature means the highest temperature in each heating step.

The temperature rising rate in the present specification is calculated from the time taken while the temperature begins to be raised and reaches the highest holding temperature in a calcining device and a temperature difference between the temperature in the calcining furnace of the calcining device at the time of beginning to raise the temperature and the highest holding temperature.

### (Step of Manufacturing LiMO)

In the step, after drying the metal composite oxide or metal composite hydroxide described above, the metal composite oxide or metal composite hydroxide is mixed with a lithium compound.

As the lithium compound, it is possible to use any one of lithium carbonate, lithium nitrate, lithium acetate, lithium hydroxide, lithium oxide, lithium chloride, and lithium fluoride, or a mixture of two or more thereof. Among these, any one or both of lithium hydroxide and lithium carbonate are preferable.

In a case where the lithium hydroxide contains lithium carbonate as an impurity, the content of the lithium carbonate in the lithium hydroxide is preferably 5% by mass or less.

Drying conditions of the metal composite oxide or metal composite hydroxide described above are not particularly limited. The drying conditions may be, for example, any of the following conditions 1) to 3).
1) Conditions in which the metal composite oxide or metal composite hydroxide is not oxidized or reduced;
specifically, a drying condition in which an oxide remains as an oxide as it is or a drying condition in which a hydroxide remains as a hydroxide as it is.
2) a condition in which the metal composite hydroxide is oxidized; specifically, a drying condition in which the hydroxide is oxidized to an oxide.
3) a condition in which the metal composite oxide is reduced; specifically, a drying condition in which the oxide is reduced to a hydroxide.

Under the condition in which oxidation or reduction do not occur, an inert gas such as nitrogen, helium or argon may be used as the atmosphere during the drying.

Under the condition in which the hydroxide is oxidized, oxygen or air may be used as the atmosphere during the drying.

In addition, under the condition in which the metal composite oxide is reduced, a reducing agent such as hydrazine and sodium sulfite may be used in the inert gas atmosphere during the drying.

After the drying, the metal composite oxide or metal composite hydroxide may be classified as appropriate.

The above-described lithium compound and the MCC are used in consideration of the compositional ratio of the final target product. For example, in a case where the nickel-cobalt-manganese composite compound is used, the lithium compound and the MCC are used in a proportion corresponding to the compositional ratio of LiNi_{(1-y-z)}Co_{y}Mn_{z}O₂ (in the formula, y+z<1). In addition, in a case where lithium is excessive (the content molar ratio is more than 1) in the LiMO, which is the final target product, the lithium compound and the MCC are mixed at a proportion of a molar ratio of lithium contained in the lithium compound to the metal element contained in the MCC being more than 1.

The mixture of the nickel-cobalt-manganese composite compound and the lithium compound is calcined to obtain a lithium-nickel-cobalt-manganese composite oxide. In the calcining, dry air, an oxygen atmosphere, an inert atmosphere, or the like is used depending on a desired composition, and a plurality of heating steps are carried out as necessary.

As a holding temperature, specifically, a range of 200° C. to 1150° C. is an exemplary example, preferably 300° C. to 1050° C. and more preferably 500° C. to 1000° C.

In addition, as a time for holding at the holding temperature, 0.1 to 20 hours is an exemplary example, preferably 0.5 to 10 hours. A temperature rising rate up to the holding temperature is usually 50 to 400° C./hour, and a temperature decreasing rate from the above-described holding temperature to room temperature is usually 10 to 400° C./hour. In addition, as the calcining atmosphere, it is possible to use air, oxygen, nitrogen, argon, or a mixed gas thereof.

The mixture of the nickel-cobalt-manganese composite compound and the lithium compound may be subjected to a plurality of calcining steps at different calcining temperatures, and it is preferable to perform primary calcining, and secondary calcining at a higher temperature than the primary calcining.

The calcining temperature of the primary calcining may be set to, for example, 500° C. to 700° C. The calcining time of the primary calcining may be set to, for example, 3 to 7 hours.

The calcining temperature of the secondary calcining is preferably 750° C. to 950° C. and more preferably 800° C. to 900° C. The calcining time of the secondary calcining may be set to, for example, 3 to 7 hours.

In the secondary calcining, the temperature rising rate in the heating step until the highest holding temperature is reached is preferably 115° C./hour or more, more preferably 120° C./hour or more, and particularly preferably 125° C./hour or more.

In the secondary calcining, the temperature decreasing rate at which the temperature is lowered from the highest holding temperature is preferably 115° C./hour or more, more preferably 120° C./hour or more, and particularly preferably 125° C./hour or more.

By setting the calcining temperature, the temperature rising rate, and the temperature decreasing rate in the secondary calcining to be within the above-described ranges, the LiMO satisfying (A) is easily obtained.

### (Arbitrary Drying Step)

It is preferable that the obtained calcined product be dried. By drying after the calcining, it is possible to reliably remove moisture remaining in the fine pores. The moisture remaining in the fine pores causes deterioration of the electrolyte in a case of manufacturing the electrode. By drying after the calcining to remove the moisture remaining in the fine pores, the deterioration of the electrolyte can be prevented.

A drying method after the calcining is not particularly limited as long as the moisture remaining in the LiMO can be removed.

As the drying method after the calcining, for example, a vacuum drying treatment under vacuum or a drying treatment using a hot air dryer is preferable.

The drying temperature is, for example, preferably 80° C. to 140° C.

The drying time is not particularly limited as long as the moisture can be removed, and for example, 5 to 12 hours is an exemplary example.

By the above-described steps, the LiMO satisfying (A) is obtained.

The coating layer is a compound containing an element A.

The element A is one or more elements selected from the group consisting of Nb, Ta, Ti, Al, B, P, W, Zr, La, and Ge. The coating layer preferably has lithium-ion conductivity.

It is preferable that the coating layer contain a lithium composite oxide containing the element A as a main component. The lithium composite oxide containing the element A is, for example, at least one oxide selected from the group consisting of LiNbO₃, LiTaO₃, Li₂TiO₃, LiAlO₂, Li₂WO₄, Li₄WO₅, Li₃BO₃, Li₂B₄O₇, Li₂ZrO₃, Li₃PO₄, Li₇La₃Zr₂O₁₂ (LLZ), Li_{1.5}Al_{0.5}Ge_{1.5}P₃O₁₂ (LAGP), Li_{1.3}Al_{0.3}Ti_{1.7}P₃O₁₂ (LATP), and Li₅La₃Ta₂O₁₂ (LLT).

The “using as the main component” the above-described oxide for the coating layer means that the content of the above-described oxide is the highest among forming materials of the coating layer. The content of the above-described oxide with respect to the entire coating layer is preferably 50 mol % or more, and more preferably 60 mol % or more. In addition, the content of the above-described oxide with respect to the entire coating layer is preferably 90 mol % or less.

As a combination of a case in which the coating layer contains two or more kinds of the above-described oxides, for example, a combination of LiNbO₃ and Li₃BO₃ and a combination of Li₃PO₄ and Li₃BO₃ are exemplary examples.

As the coating material raw material contained in the coating liquid, the above-described lithium compound and an oxide, a hydroxide, a carbonate, a nitrate, a sulfate, a halide, a formate, an oxalate, or an alkoxide of the element A can be used.

The coating material raw material is, for example, a raw material of lithium niobate. In a case of forming the coating layer, a coating liquid containing the coating material raw material and a solvent is used.

In addition to the lithium niobate, lithium tantalate, lithium titanate, lithium aluminate, lithium tungstate, lithium phosphate, and lithium borate are exemplary examples.

As a Li source of the lithium niobate, for example, Li alkoxide, Li inorganic salt, and Li hydroxide are exemplary examples.

As the Li alkoxide, for example, ethoxy lithium and methoxy lithium are exemplary examples.

As the Li inorganic salt, for example, lithium nitrate, lithium sulfate, and lithium acetate are exemplary examples. As the Li hydroxide, for example, lithium hydroxide is an exemplary example.

As a Ta source of the lithium tantalate, tantalum oxide and pentaethoxytantalum are exemplary examples. As a Ti source of the lithium titanate, for example, titanium oxide and tetraethoxytitanium are exemplary examples. As an Al source of the lithium aluminate, aluminum oxide is an exemplary example. As a W source of the lithium tungstate, tungsten oxide is an exemplary example. As a P source of the lithium phosphate, ammonium dihydrogenphosphate and diammonium hydrogenphosphate are exemplary examples. As a B source of the lithium borate, boric acid and boron oxide are exemplary examples.

As a Nb source of the lithium niobate, for example, Nb alkoxide, Nb inorganic salt, Nb hydroxide, and Nb complex are exemplary examples.

As the Nb alkoxide, for example, pentaethoxy niobium, pentamethoxy niobium, penta-i-propoxy niobium, penta-n-propoxy niobium, penta-i-butoxy niobium, penta-n-butoxy niobium, and penta-sec-butoxy niobium are exemplary examples.

As the Nb inorganic salt, for example, niobium acetate and the like are exemplary examples.

As the Nb hydroxide, for example, niobium hydroxide is an exemplary example.

As the Nb complex, for example, a peroxo complex of Nb (peroxoniobate complex [Nb(O₂)₄]³⁻) is an exemplary example.

The coating liquid containing the peroxo complex of Nb has an advantage in that the amount of gas generated from the coating layer in the coating treatment and after the heat treatment is smaller than that in the coating liquid containing the Nb alkoxide, and thus a high-density coating layer is easily obtained.

As a method for preparing the coating liquid containing the peroxo complex of Nb, for example, a method of adding hydrogen peroxide water and ammonia water to a Nb oxide or a Nb hydroxide is an exemplary example. Addition amounts of the hydrogen peroxide water and the ammonia water may be appropriately adjusted so that a transparent solution (uniform solution) is obtained.

The type of the solvent in the coating liquid is not particularly limited, and alcohol, water, and the like are exemplary examples.

As the alcohol, for example, methanol, ethanol, propanol, butanol, and the like are exemplary examples. For example, in a case where the coating liquid contains an alkoxide, the solvent is preferably anhydrous alcohol or dewatered alcohol. On the other hand, for example, in a case where the coating liquid contains a peroxo complex of Nb, the solvent is preferably water.

### Physical Properties of LiMO>>

The LiMO has a layered crystal structure and contains at least Li, Ni, and a transition metal.

The LiMO contains, as the transition metal, at least one selected from the group consisting of Co, Mn, Fe, Cu, Mg, Al, W, B, Mo, Zn, Sn, Zr, Ga, La, Ti, Nb, and V.

In a case where the LiMO contains the above-described element as the transition metal, the obtained LiMO forms a stable crystal structure from which the Li ions can be easily removed or inserted.

More specifically, the LiMO is represented by the following compositional formula (I).

Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Ta, Nb, and V, and −0.10≤x≤0.30, 0≤y≤0.40, 0≤z≤0.40, 0≤w≤0.10, and y+z+w<1 are satisfied)

### (Regarding x)

From the viewpoint of obtaining a lithium-ion secondary battery having favorable cycle characteristics, x in the compositional formula (I) is preferably more than 0, more preferably 0.01 or more, and still more preferably 0.02 or more. In addition, from the viewpoint of obtaining a lithium secondary battery having a higher initial charge and discharge efficiency, x in the compositional formula (I) is preferably 0.25 or less, and more preferably 0.10 or less.

In the present specification, “favorable cycle characteristics” means a characteristic in which a decrease in battery capacity due to repeated charging and discharging is small, and means that a capacity ratio in re-measurement with respect to the initial capacity is unlikely to decrease.

In addition, in the present specification, the “initial charge and discharge efficiency” is a value obtained by “(Initial discharge capacity)/(Initial charge capacity)×100(%)”. The secondary battery having a high initial charge and discharge efficiency has a small irreversible capacity during the first charging and discharging, and is likely to have a larger capacity per volume and weight.

The upper limit value and lower limit value of x can be randomly combined together. In the compositional formula (I), x may be −0.10 to 0.25, or −0.10 to 0.10.

x may be more than 0 and 0.30 or less, more than 0 and 0.25 or less, or more than 0 and 0.10 or less.

x may be 0.01 to 0.30, 0.01 to 0.25, or 0.01 to 0.10.

x may be 0.02 to 0.3, 0.02 to 0.25, or 0.02 to 0.10.

It is preferable that x satisfy 0<x≤0.30.

### (Regarding y)

In addition, from the viewpoint of obtaining a lithium-ion secondary battery having low internal resistance, y in the compositional formula (I) is preferably more than 0, more preferably 0.005 or more, still more preferably 0.01 or more, and particularly preferably 0.05 or more. In addition, from the viewpoint of obtaining a lithium secondary battery having high thermal stability, y in the compositional formula (I) is more preferably 0.35 or less, still more preferably 0.33 or less, and even more preferably 0.30 or less.

The upper limit value and lower limit value of y can be randomly combined together. In the compositional formula (I), y may be 0 to 0.35, 0 to 0.33, or 0 to 0.30.

y may be more than 0 and 0.40 or less, more than 0 and 0.35 or less, more than 0 and 0.33 or less, or more than 0 and 0.30 or less.

y may be 0.005 to 0.40, 0.005 to 0.35, 0.005 to 0.33, or 0.005 to 0.30.

y may be 0.01 to 0.40, 0.01 to 0.35, 0.01 to 0.33, or 0.01 to 0.30.

y may be 0.05 to 0.40, 0.05 to 0.35, 0.05 to 0.33, or 0.05 to 0.30.

It is preferable that y satisfy 0<y≤0.40.

In the compositional formula (I), it is more preferable that 0<x≤0.10 and 0<y≤0.40.

### (Regarding z)

In addition, from the viewpoint of obtaining a lithium secondary battery having favorable cycle characteristics, z in the compositional formula (I) is preferably more than 0, more preferably 0.01 or more, still more preferably 0.02 or more, and particularly preferably 0.1 or more. In addition, from the viewpoint of obtaining a lithium secondary battery having high storage stability at a high temperature (for example, under an environment of 60° C.), z in the compositional formula (I) is preferably 0.39 or less, more preferably 0.38 or less, and still more preferably 0.35 or less.

The upper limit value and lower limit value of z can be randomly combined together. In the compositional formula (I), z may be 0 to 0.39, 0 to 0.38, or 0 to 0.35.

z may be 0.01 to 0.40, 0.01 to 0.39, 0.01 to 0.38, or 0.01 to 0.35.

z may be 0.02 to 0.40, 0.02 to 0.39, 0.02 to 0.38, or 0.02 to 0.35.

z may be 0.10 to 0.40, 0.10 to 0.39, 0.10 to 0.38, or 0.10 to 0.35.

### (Regarding w)

In addition, from the viewpoint of obtaining a lithium secondary battery having low internal resistance, w in the compositional formula (I) is preferably more than 0, more preferably 0.0005 or more, and still more preferably 0.001 or more. In addition, from the viewpoint of obtaining a lithium secondary battery having a large discharge capacity at a high current rate, w in the compositional formula (I) is preferably 0.09 or less, more preferably 0.08 or less, and still more preferably 0.07 or less.

The upper limit value and lower limit value of w can be randomly combined together. In the compositional formula (I), w may be 0 to 0.09, 0 to 0.08, or 0 to 0.07.

w may be more than 0 and 0.10 or less, more than 0 and 0.09 or less, more than 0 and 0.08 or less, or more than 0 and 0.07 or less.

w may be 0.0005 to 0.10, 0.0005 to 0.09, 0.0005 to 0.08, or 0.0005 to 0.07.

w may be 0.001 to 0.10, 0.001 to 0.09, 0.001 to 0.08, or 0.001 to 0.07.

(Regarding y+z+w)

In addition, from the viewpoint of obtaining a lithium secondary battery having a large battery capacity, y+z+w in the compositional formula (1) is preferably 0.50 or less, more preferably 0.48 or less, and still more preferably 0.46 or less.

With regard to the LiMO, it is preferable that, in the compositional formula (I), 0.50≤1−y−z−w≤0.95 and 0≤y≤0.30. That is, it is preferable that the LiMO have a Ni content molar ratio of 0.50 or more and a Co content molar ratio of 0.30 or less in the compositional formula (I).

### (Regarding M)

M in the compositional formula (I) represents one or more elements selected from the group consisting of Fe, Cu, Mg, Al, W, B, Mo, Zn, Sn, Zr, Ga, La, Ti, Nb, and V.

In addition, from the viewpoint of obtaining a lithium secondary battery having high cycle characteristics, M in the compositional formula (I) is preferably one or more elements selected from the group consisting of Mg, Al, W, B, and Zr; and more preferably one or more elements selected from the group consisting of Al and Zr. In addition, from the viewpoint of obtaining a lithium secondary battery having high thermal stability, M is preferably one or more elements selected from the group consisting of Al, W, B, and Zr.

An example of a preferred combination of x, y, z, and w described above is that x is 0.02 to 0.3, y is 0.05 to 0.30, z is 0.02 to 0.35, and w is 0 to 0.07.

As the LiMO having a preferred combination of x, y, z, and w, for example, the LiMO in which x=0.05, y=0.20, z=0.30, and w=0; the LiMO in which x=0.05, y=0.08, z=0.04, and w=0; and the LiMO in which x=0.25, y=0.07, z=0.02, and w=0 are exemplary examples.

In a case where the element A constituting the coating layer and the transition metal element constituting the LiMO overlap, the overlapping element is treated as the element constituting the coating layer.

### [Composition Analysis]

A composition of the LiMO can be analyzed using an inductively coupled plasma emission spectrometer (for example, SPS3000 manufactured by Seiko Instruments Inc.) after the LiMO is dissolved in hydrochloric acid.

### (Crystal Structure)

A crystal structure of the LiMO is layered. The crystal structure of the LiMO is more preferably a hexagonal crystal structure or a monoclinic crystal structure.

The hexagonal crystal structure belongs to any one space group selected from the group consisting of P3, P3₁, P3₂, R3, P-3, R-3, P312, P321, P3₁12, P3₁21, P3₂12, P3₂21, R32, P3 ml, P31m, P3c1, P31c, R3m, R3c, P-31m, P-31c, P-3 ml, P-3c1, R-3m, R-3c, P6, P6₁, P6₅, P6₂, P6₄, P6₃, P-6, P6/m, P63/m, P622, P6₁22, P6₅22, P6₂22, P6₄22, P6₃22, P6 mm, P6cc, P6₃ cm, P6₃mc, P-6m2, P-6c2, P-62m, P-62c, P6/mmm, P6/mcc, P6₃/mcm, and P6₃/mmc.

In addition, the monoclinic crystal structure belongs to any one space group selected from the group consisting of P2, P2₁, C2, Pm, Pc, Cm, Cc, P2/m, P2₁/m, C2/m, P2/c, P2₁/c, and C2/c.

Among these, in order to obtain a lithium secondary battery having a high discharge capacity, the crystal structure is particularly preferably a hexagonal crystal structure belonging to the space group R-3m or a monoclinic crystal structure belonging to the space group C2/m.

It is preferable that the LiMO contain secondary particles which are an aggregate of primary particles.

In the present specification, “primary particles” means particles that have no grain boundary in appearance and constitute the secondary particles. In more detail, “primary particles” means particles in which no clear grain boundary is visible from the particle surface in the case of being observed in a visual field magnified 5,000 times or more and 20,000 times or less with a scanning electron microscope or the like.

In the present specification, “secondary particles” means particles in which a plurality of the primary particles are three-dimensionally bonded to each other with a gap. The secondary particles have a spherical shape or a substantially spherical shape.

In general, the secondary particles are formed by aggregation of 10 or more of the primary particles.

### [Calculation of Integrated Value of Cumulative Frequency (%)]

In the cumulative particle size distribution curve of the LiMO, a particle size distribution curve (0.4) in a case of measuring with a dispersion air pressure of 0.4 MPa and a particle size distribution curve (0.1) in a case of measuring with a dispersion pressure of 0.1 MPa are obtained.

An integrated value of a cumulative frequency (%) from the minimum value of the particle diameter in the particle size distribution curve (0.4) to the minimum value of the particle diameter in the particle size distribution curve (0.1) is preferably 28% or less, more preferably 20% or less, and still more preferably 10% or less.

As the lower limit value of the integrated value, for example, 0% or more, 0.001% or more, and 0.005% or more are exemplary examples.

The above-described upper limit value and lower limit value of the integrated value can be randomly combined together.

As the combination, 0% to 28%, 0.001% to 20%, and 0.005% to 10% are exemplary examples.

FIG. 4(a) shows the particle size distribution curve (0.4) and the particle size distribution curve (0.1) of the LiMO according to the present embodiment. In the LiMO according to the present embodiment, the integrated value (oblique line portion in FIG. 4(a)) of the cumulative frequency (%) from the minimum value of the particle diameter in the particle size distribution curve (0.4) to the minimum value of the particle diameter in the particle size distribution curve (0.1) is small. This means that the shape of the particle size distribution curve is not significantly changed because chipping is less likely to occur even in a case where the high-pressure air is blown.

FIG. 4(b) shows the particle size distribution curve (0.4) and the particle size distribution curve (0.1) of LiMO other than the present embodiment. In the LiMO other than the present embodiment, the integrated value (oblique line portion in FIG. 4(a)) of the cumulative frequency (%) from the minimum value of the particle diameter in the particle size distribution curve (0.4) to the minimum value of the particle diameter in the particle size distribution curve (0.1) is large.

This means that the shape of the cumulative particle size distribution curve is significantly changed because chipping occurs by blowing the high-pressure air.

### [Evaluation of Relationship Between Dispersion Air Pressure and Particle Diameter]

In the cumulative particle size distribution curve of the LiMO according to the present embodiment, coordinates are obtained by plotting the dispersion air pressure (MPa) on the horizontal axis, and the particle diameter D₁₀ (μm) at which the cumulative proportion from the small particle side is 10% on the vertical axis. At the coordinates, the absolute value of a slope of a straight line, obtained by connecting a point at which the dispersion air pressure (MPa) is 0.4 MPa and a point at which the dispersion air pressure (MPa) is 0.1 MPa, is preferably 19 or less, more preferably 10 or less, and still more preferably 5 or less.

The lower limit value of the above-described absolute value is, for example, 0.1 or more, 0.2 or more, or 0.3 or more.

The above-described upper limit value and lower limit value of the above-described absolute value can be randomly combined together. As the combination, 0.1 to 19, 0.2 to 10, and 0.3 to 5 are exemplary examples.

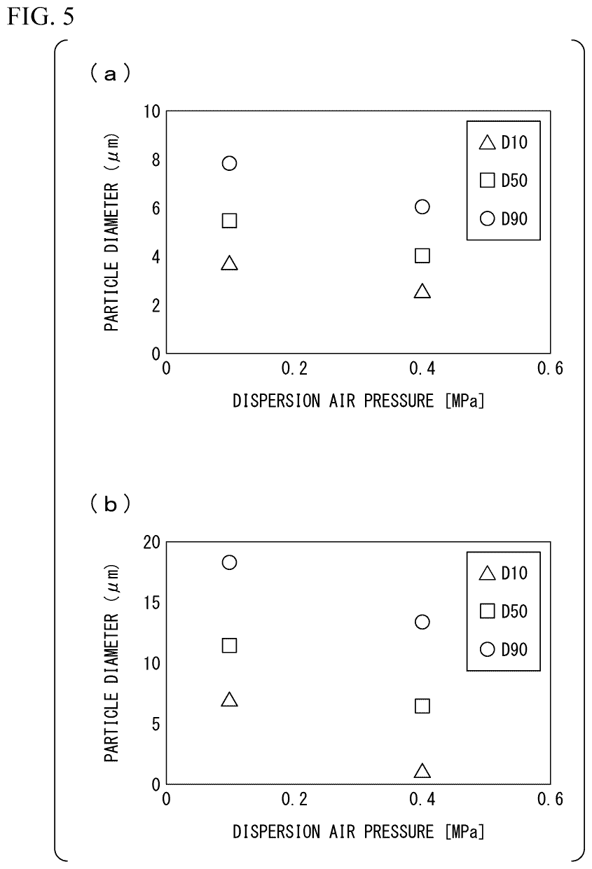

FIG. 5(a) shows the coordinates of the LiMO according to the present embodiment. From FIG. 5(a), it is found that the above-described absolute value of the slope of the straight line is as small as 19 or less. This means that fine particles having a diameter corresponding to D₁₀ (μm) are not increased even in a case where the dispersion air pressure is increased from 0.1 MPa to 0.4 MPa, that is, chipping is less likely to occur even in a case where the high-pressure air is blown.

FIG. 5(b) shows the coordinates of LiMO other than the present embodiment. From FIG. 5(b), it is found that the above-described absolute value of the slope of the straight line is as large as more than 19. This means that fine particles having a diameter corresponding to D₁₀ (μm) are increased in a case where the dispersion air pressure is increased from 0.1 MPa to 0.4 MPa, that is, chipping is likely to occur by blowing the high-pressure air.

### <Cathode Active Material for Lithium Secondary Battery>

The CAM includes the LiMO and a coating layer which coats at least a part of the LiMO, in which the following (X) to (Z) are satisfied.
(X) coverage of the LiMO is 70% or more

$$( {WD}_{50} - {WD}_{min} ) / {WD}_{50} \leq 0.6 \qquad ( Y )$$

(in a volume-based cumulative particle size distribution obtained by a wet particle size distribution measurement using a laser diffraction type particle size distribution analyzer, a particle diameter (μm) at which a cumulative proportion from a small particle side is 50% is defined as WD₅₀, and a minimum particle diameter (μm) in the obtained cumulative particle size distribution curve is defined as WDₘᵢₙ)

$${Z}_{0.4} / {Z}_{0.1} < 1.7 \qquad ( Z )$$

(in a volume-based cumulative particle size distribution of the CAM, which is obtained by a dry particle size distribution measurement using a laser diffraction type particle size distribution analyzer, Z_{0.4} is a value of (D₉₀−D₁₀)/D₅₀ in a case of measuring with a dispersion air pressure of 0.4 MPa and Z_{0.1} is a value of (D₉₀−D₁₀)/D₅₀ in a case of measuring with a dispersion air pressure of 0.1 MPa, in the cumulative particle size distribution, a particle diameter at which a cumulative proportion from a small particle side is 10%, 50%, or 90% is defined as D₁₀, D₅₀, or D₉₀)

The coverage of the LiMO is measured as a surface presence rate of the element A.

The surface presence rate of the element A is more preferably 75% or more, and still more preferably 80% or more.

The surface presence rate of the element A is, for example, 100% or less, 99% or less, or 98% or less.

The above-described upper limit value and lower limit value of the surface presence rate of the element A can be randomly combined together. The surface presence rate of the element A is, for example, 70% to 100%, 75% to 99%, or 80% to 98%.

### [Method for Measuring Surface Presence Rate of Element A]

Since the element A is present in the coating layer of the CAM, in a case where the XPS analysis is performed on the CAM, photoelectrons corresponding to the kinetic energy of the element A present in the coating layer are detected.

The presence rate of the element A in the CAM is determined by using one particle of the CAM as a measurement target and analyzing the CAM by XPS.

Specifically, surface composition analysis of the CAM is performed under the following conditions to obtain a narrow scan spectrum on the surface of the CAM.
Measurement method: X-ray photoelectron spectroscopy (XPS)
X-ray radiation source: AlKα radiation (1486.6 eV)
X-ray spot diameter: 100 μm
Neutralization conditions: neutralization electron gun (acceleration voltage is adjusted depending on the element; current: 100 μA)

A detection depth of the XPS under the above-described conditions is in a range of approximately 3 nm from the surface of the CAM to the inside. In the CAM, in a portion where the coating layer is thin or the coating layer is not provided, the surface of the LiMO is analyzed in addition to the coating layer.

The peak corresponding to each element can be identified using an existing database.

As a photoelectron intensity of Nb as the element A, an integrated value of a waveform of Nb3d is used.

As a photoelectron intensity of Ta as the element A, an integrated value of a waveform of Ta4f is used.

As a photoelectron intensity of Ti as the element A, an integrated value of a waveform of Ti2p is used.

As a photoelectron intensity of Al as the element A, an integrated value of a waveform of A12p is used.

As a photoelectron intensity of B as the element A, an integrated value of a waveform of B1s is used.

As a photoelectron intensity of P as the element A, an integrated value of a waveform of P2p is used.

As a photoelectron intensity of W as the element A, an integrated value of a waveform of W4f is used. However, in a case of measuring at the same time as Ge, an integrated value of a background of W4d is used.

As a photoelectron intensity of Zr as the element A, an integrated value of a waveform of Zr3d is used.

As a photoelectron intensity of La as the element A, an integrated value of a waveform of La3d5/2 is used.

As a photoelectron intensity of Ge as the element A, an integrated value of a waveform of Ge2p is used.

In addition, in the same XPS analysis, photoelectrons corresponding to the kinetic energy of each element are also detected for the transition metal contained in the LiMO.

As the transition metal contained in the LiMO, for example, an integrated value of a waveform of Ni2p3/2 is used as a photoelectron intensity of Ni.

As the transition metal contained in the LiMO, an integrated value of a waveform of Co2p3/2 is used as a photoelectron intensity of Co.

As the transition metal contained in the LiMO, an integrated value of a waveform of Mn2p1/2 is used as a photoelectron intensity of Mn.

The ratio of values obtained by performing sensitivity correction for each element from the photoelectron intensity of each element in the obtained spectrum corresponds to the element ratio of the CAM obtained by the XPS measurement.

In the CAM to be measured, there is a case in which an element common to the coating layer and the LiMO is contained. In this case, the above-described element ratio in the XPS analysis result is handled without distinguishing whether the element is an element contained in the coating layer or an element contained in the LiMO.

For example, in a case where Ti is contained in both the coating layer and the LiMO, the element ratio of Ti obtained as the XPS analysis result is handled as the total element ratio of Ti contained in the LiMO and Ti contained in the coating layer.

The CAM satisfies the following (Y).

$$( {WD}_{50} - {WD}_{min} ) / {WD}_{50} \leq 0.6 \qquad ( Y )$$

(in a volume-based cumulative particle size distribution obtained by a wet particle size distribution measurement using a laser diffraction type particle size distribution analyzer, a particle diameter (μm) at which a cumulative proportion from a small particle side is 50% is defined as WD₅₀, and a minimum particle diameter (μm) in the obtained cumulative particle size distribution curve is defined as WDₘᵢₙ)
   [Measurement of WD₅₀ and WDₘᵢₙ by Wet Particle Size Distribution Measurement]

The measurement of WD₅₀ and WDₘᵢₙ of the CAM by the wet particle size distribution measurement is performed by the following method.

Specifically, 0.1 g of a powder of the CAM is added to 50 ml of a 0.2% by mass sodium hexametaphosphate aqueous solution to obtain a dispersion liquid in which the powder is dispersed. The particle size distribution of the obtained dispersion liquid is measured using a laser diffraction particle size distribution analyzer (MS2000 manufactured by Malvern Panalytical Ltd.) to obtain a volume-based cumulative particle size distribution curve. In the cumulative particle size distribution curve obtained by the wet particle size distribution measurement, a value of the particle diameter at a cumulative 50% is defined as WD₅₀, and the minimum particle diameter (μm) is defined as WDₘᵢₙ.

The CAM satisfying (Y) has small fine particles.

The CAM satisfies the following (Z).

$${Z}_{0.4} / {Z}_{0.1} < 1.7 \qquad ( Z )$$

(in a volume-based cumulative particle size distribution curve of the cathode active material for lithium secondary battery, which is obtained by a dry particle size distribution measurement using a laser diffraction type particle size distribution analyzer, Z_{0.4} is a value of (D₉₀−D₁₀)/D₅₀ in a case of measuring with a dispersion air pressure of 0.4 MPa and Z_{0.1} is a value of (D₉₀−D₁₀)/D₅₀ in a case of measuring with a dispersion air pressure of 0.1 MPa, in the cumulative particle size distribution curve, a particle diameter at which a cumulative proportion from a small particle side is 10%, 50%, or 90% is defined as D₁₀, D₅₀, or D₉₀)

The CAM satisfying (Z) has small fine particles.

In a case of the lithium-ion secondary battery, it is difficult to secure a conductive path by the fine particles generated by chipping. Therefore, the fine particles generated by chipping are less likely to contribute to the charging and discharging. That is, in a case of a lithium-ion secondary battery, regardless of whether the electrolyte is an electrolytic solution or a solid electrolyte, the battery characteristics are improved as the amount of the fine particles generated by chipping becomes smaller.

Among these, in a case of a solid lithium-ion secondary battery in which the electrolyte is solid, since the electrolyte has poor fluidity, it is difficult to secure the ion conduction path by the fine particles generated by chipping, and thus the influence of the fine particles generated by chipping is more likely to be received than in a case of an electrolytic solution as the electrolyte.

The CAM satisfying (Z) has few fine particles in the first place, and thus the LiMO particles are less likely to be broken in a case where a pressure is applied during manufacturing or use.

Here, in a case of manufacturing the solid lithium-ion secondary battery, a pressure is applied to the cathode active material powder in a case of mixing the powder or in a case of performing compacting.

Furthermore, in a case of using the solid lithium-ion secondary battery, the cathode active material powder is subjected to pressure due to expansion and contraction accompanying repetition of charging and discharging.

For example, in a case where an oxide-based solid electrolyte is used as the solid electrolyte, it is assumed that a pressure of 50 MPa or more is applied; and in a case where a sulfide-based solid electrolyte is used, it is assumed that a pressure of 200 MPa or more is applied.

In a case where the CAM satisfying (Z) is repeatedly used, fine particles are less likely to be generated. That is, since the conductive path for the lithium-ions is not reduced even in cases of repeated use, the capacity does not easily decrease. Therefore, the characteristics of the solid lithium-ion secondary battery can be improved.

### (Compositional Formula)

The CAM preferably satisfies the following formula (II).

(Li[Liₐ(Ni_{(1-b-c-d)}Co_{b}Mn_{c}X_{d})₁₋ₐ]O₂ (II)
(here, X is at least one element selected from the group consisting of Fe, Cu, Mg, Al, W, B, P, Mo, Zn, Sn, Zr, Ga, La, Ti, Nb, Ta, Ge, and V, and −0.10≤a≤0.30, 0≤b≤0.40, 0≤c≤0.40, and 0<d≤0.10 are satisfied)

### (Regarding a)

From the viewpoint of obtaining a lithium-ion secondary battery having favorable cycle characteristics, a in the compositional formula (II) is preferably more than 0, more preferably 0.01 or more, and still more preferably 0.02 or more. In addition, from the viewpoint of obtaining a lithium secondary battery having a higher initial charge and discharge efficiency, a in the compositional formula (II) is preferably 0.25 or less, and more preferably 0.10 or less.

The upper limit value and lower limit value of a can be randomly combined together. In the compositional formula (II), a may be −0.10 to 0.25, or −0.10 to 0.10.

a may be more than 0 and 0.30 or less, more than 0 and 0.25 or less, or more than 0 and 0.10 or less.

a may be 0.01 to 0.30, 0.01 to 0.25, or 0.01 to 0.10.

a may be 0.02 to 0.3, 0.02 to 0.25, or 0.02 to 0.10.

It is preferable that a satisfy 0<a≤0.30.

### (Regarding b)

In addition, from the viewpoint of obtaining a lithium-ion secondary battery having low internal resistance, b in the compositional formula (II) is preferably more than 0, more preferably 0.005 or more, still more preferably 0.01 or more, and particularly preferably 0.05 or more. In addition, from the viewpoint of obtaining a lithium secondary battery having high thermal stability, b in the compositional formula (II) is more preferably 0.35 or less, still more preferably 0.33 or less, and even more preferably 0.30 or less.

The upper limit value and lower limit value of b can be randomly combined together. In the compositional formula (II), b may be 0 to 0.35, 0 to 0.33, or 0 to 0.30.

b may be more than 0 and 0.40 or less, more than 0 and 0.35 or less, more than 0 and 0.33 or less, or more than 0 and 0.30 or less.

b may be 0.005 to 0.40, 0.005 to 0.35, 0.005 to 0.33, or 0.005 to 0.30.

b may be 0.01 to 0.40, 0.01 to 0.35, 0.01 to 0.33, or 0.01 to 0.30.

b may be 0.05 to 0.40, 0.05 to 0.35, 0.05 to 0.33, or 0.05 to 0.30.

It is preferable that b satisfy 0<b≤0.40.

In the compositional formula (II), it is more preferable that 0<a≤0.10 and 0<b≤0.40.

### (Regarding c)

In addition, from the viewpoint of obtaining a lithium secondary battery having favorable cycle characteristics, c in the compositional formula (II) is preferably more than 0, more preferably 0.01 or more, still more preferably 0.02 or more, and particularly preferably 0.1 or more. In addition, from the viewpoint of obtaining a lithium secondary battery having high storage stability at a high temperature (for example, under an environment of 60° C.), c in the compositional formula (II) is preferably 0.39 or less, more preferably 0.38 or less, and still more preferably 0.35 or less.

The upper limit value and lower limit value of c can be randomly combined together. In the compositional formula (II), c may be 0 to 0.39, 0 to 0.38, or 0 to 0.35.

c may be 0.01 to 0.40, 0.01 to 0.39, 0.01 to 0.38, or 0.01 to 0.35.

c may be 0.02 to 0.40, 0.02 to 0.39, 0.02 to 0.38, or 0.02 to 0.35.

c may be 0.10 to 0.40, 0.10 to 0.39, 0.10 to 0.38, or 0.10 to 0.35.

### (Regarding d)

In addition, from the viewpoint of obtaining a lithium secondary battery having low internal resistance, d in the compositional formula (II) is preferably more than 0, more preferably 0.0005 or more, and still more preferably 0.001 or more. In addition, from the viewpoint of obtaining a lithium secondary battery having a large discharge capacity at a high current rate, d in the compositional formula (II) is preferably 0.09 or less, more preferably 0.08 or less, and still more preferably 0.07 or less.

The upper limit value and lower limit value of d can be randomly combined together. In the compositional formula (II), d may be more than 0 and 0.10 or less, more than 0 and 0.09 or less, more than 0 and 0.08 or less, or more than 0 and 0.07 or less.

d may be 0.0005 to 0.10, 0.0005 to 0.09, 0.0005 to 0.08, or 0.0005 to 0.07.

d may be 0.001 to 0.10, 0.001 to 0.09, 0.001 to 0.08, or 0.001 to 0.07.

(Regarding b+c+d)

In addition, from the viewpoint of obtaining a lithium secondary battery having a large battery capacity, b+c+d in the compositional formula (II) is preferably 0.50 or less, more preferably 0.48 or less, and still more preferably 0.46 or less.

The CAM preferably satisfies 0.50≤1−b−c−d≤0.95 and 0≤b≤0.30 in the compositional formula (II). That is, it is preferable that the CAM have a Ni content molar ratio of 0.50 or more and a Co content molar ratio of 0.30 or less in the compositional formula (II).

In addition, from the viewpoint of obtaining a lithium secondary battery having high cycle characteristics, it is preferable that X in the compositional formula (II) be Nb, P, or B.

An example of a preferred combination of a, b, c, and d described above is that a is 0.02 to 0.3, b is 0.05 to 0.30, c is 0.02 to 0.35, and d is more than 0 and 0.07 or less.

As the CAM having a preferred combination of a, b, c, and d, for example, the CAM in which a=0.05, b=0.20, c=0.30, and d=0.0005; the CAM in which a=0.05, b=0.08, c=0.04, and d=0.0005; and the CAM in which a=0.25, b=0.07, c=0.02, and d=0.0005 are exemplary examples.

The CAM is preferably a cathode active material for solid lithium secondary battery.

### <Lithium Secondary Battery>

Next, a configuration of a suitable lithium secondary battery in a case of using the CAM manufactured by the present embodiment will be described.

In addition, a cathode suitable for lithium secondary battery (hereinafter, may be referred to as a cathode) in a case of using the CAM manufactured by the present embodiment will be described.

Furthermore, a lithium secondary battery suitable as a cathode application will be described.

An example of the lithium secondary battery suitable for a case in which the CAM according to the present embodiment is used has a cathode, an anode, a separator interposed between the cathode and the anode, and an electrolytic solution disposed between the cathode and the anode.

An example of the lithium secondary battery has a cathode, an anode, a separator interposed between the cathode and the anode, and an electrolytic solution disposed between the cathode and the anode.

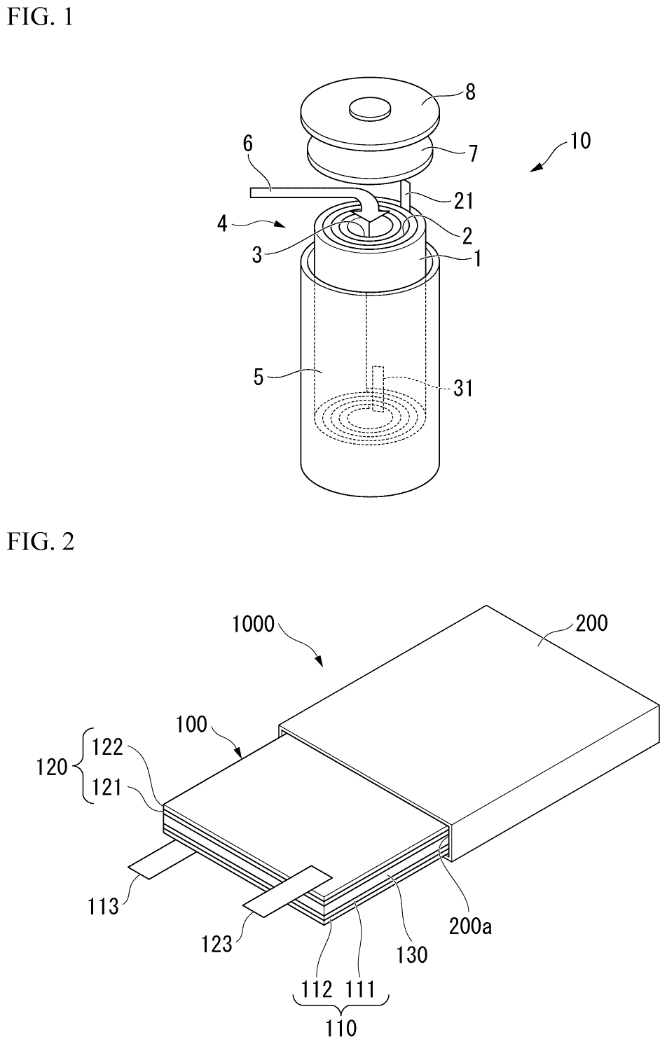

FIG. 1 is a schematic view showing an example of the lithium secondary battery. A cylindrical lithium secondary battery 10 is manufactured as described below.

First, as shown in FIG. 1, a pair of separators 1 having a strip shape, a strip-shaped cathode 2 having a cathode lead 21 at one end, and a strip-shaped anode 3 having an anode lead 31 at one end are laminated in order of the separator 1, the cathode 2, the separator 1, and the anode 3 are wound to form an electrode group 4.

Next, the electrode group 4 and an insulator (not shown) are accommodated in a battery can 5, and the can bottom is sealed. The electrode group 4 is impregnated with an electrolytic solution 6, and an electrolyte is disposed between the cathode 2 and the anode 3. Furthermore, the upper portion of the battery can 5 is sealed with a top insulator 7 and a sealing body 8, whereby the lithium secondary battery 10 can be produced.

As a shape of the electrode group 4, for example, a columnar shape in which the cross-sectional shape is a circle, an ellipse, a rectangle, or a rectangle with rounded corners in a case where the electrode group 4 is cut in a direction perpendicular to a winding axis can be an exemplary example.

In addition, as the shape of the lithium secondary battery having such an electrode group 4, a shape that is specified by IEC60086, which is a standard for battery specified by the International Electrotechnical Commission (IEC) or by JIS C 8500, can be adopted.

For example, shapes such as a cylindrical shape and a square shape can be exemplary examples.

Furthermore, the lithium secondary battery is not limited to the above-described winding-type configuration, and may have a lamination-type configuration of a laminated structure in which the cathode, the separator, the anode, and the separator are repeatedly stacked. As the lamination-type lithium secondary battery, a so-called coin-type battery, button-type battery, or paper-type (or sheet-type) battery can be exemplary examples.

Hereinafter, each configuration will be described in order.

### (Cathode)

The cathode can be manufactured by, first, preparing a cathode material mixture containing the CAM, a conductive material, and a binder, and supporting the cathode material mixture with a cathode current collector.

### (Conductive Material)

As the conductive material in the cathode, a carbon material can be used. As the carbon material, graphite powder, carbon black (for example, acetylene black), a fibrous carbon material, and the like can be exemplary examples.

A proportion of the conductive material in the cathode material mixture is preferably 5 to 20 parts by mass with respect to 100 parts by mass of the CAM.

### (Binder)

As the binder in the cathode, a thermoplastic resin can be used. As the thermoplastic resin, polyimide resins; fluororesins such as polyvinylidene fluoride (hereinafter, may be referred to as PVdF) and polytetrafluoroethylene; polyolefin resins such as polyethylene and polypropylene, and the resins described in WO2019/098384A1 or US2020/0274158A1 can be exemplary examples.

### (Cathode Current Collector)

As the cathode current collector in the cathode, a strip-shaped member formed of a metal material such as Al, Ni, and stainless steel as a forming material can be used.

As a method for supporting the cathode material mixture by the cathode current collector, a method in which a paste of the cathode material mixture is prepared using an organic solvent, the paste of the cathode material mixture to be obtained is applied to and dried on at least one surface side of the cathode current collector, and the cathode material mixture is fixed by performing an electrode pressing step is an exemplary example.

As the organic solvent which can be used in a case where the paste of the cathode material mixture is prepared, N-methyl-2-pyrrolidone (hereinafter, may be referred to as NMP) is an exemplary example.

As the method for applying the paste of the cathode material mixture to the cathode current collector, a slit die coating method, a screen coating method, a curtain coating method, a knife coating method, a gravure coating method, and an electrostatic spraying method are exemplary examples.

The cathode can be manufactured by the method mentioned above.

### (Anode)

It is sufficient that the anode in the lithium secondary battery be a material which can be doped with lithium-ions and from which lithium-ions can be de-doped at a potential lower than that of the cathode, and an electrode in which an anode material mixture containing an anode active material is supported with an anode current collector and an electrode formed of an anode active material alone are exemplary examples.

### (Anode Active Material)

As the anode active material in the anode, a carbon material, a chalcogen compound (oxide, sulfide, or the like), a nitride, a metal, or an alloy and which can be doped with lithium-ions and from which lithium-ions can be de-doped at a potential lower than that of the cathode are exemplary examples.

As the carbon material which can be used as the anode active material, graphite such as natural graphite or artificial graphite, cokes, carbon black, carbon fiber, and an organic polymer compound-calcined body can be exemplary examples.

As oxides which can be used as the anode active material, oxides of silicon represented by a formula SiOₓ (here, x is a positive real number), such as SiO₂ and SiO; oxides of tin represented by a formula SnOₓ (here, x is a positive real number), such as SnO₂ and SnO; and metal composite oxides containing lithium and titanium, such as Li₄Ti₅O₂ and LiVO₂ can be exemplary examples.

In addition, as the metal which can be used as the anode active material, lithium metal, silicon metal, tin metal, and the like can be exemplary examples. As the material which can be used as the anode active material, the materials described in WO2019/098384A1 or US2020/0274158A1 may be used.

These metals and alloys can be mainly used alone as an electrode after being processed into, for example, a foil shape.

Among the anode active materials, a carbon material containing graphite such as natural graphite or artificial graphite as a main component is preferably used because the potential of the anode rarely changes (potential flatness is favorable) from an uncharged state to a fully-charged state during charging, the average discharging potential is low, the capacity retention rate at the time of repeatedly charging and discharging the lithium secondary battery is high (the cycle characteristics are favorable), and the like. A shape of the carbon material may be, for example, any of a flaky shape such as natural graphite, a spherical shape such as mesocarbon microbeads, a fibrous shape such as a graphitized carbon fiber, or an aggregate of fine powder.

The anode material mixture may contain a binder as necessary. As the binder, thermoplastic resins can be exemplary examples, and specifically, PVdF, thermoplastic polyimide, carboxymethylcellulose (hereinafter, may be described as CMC), styrene-butadiene rubber (hereinafter, may be described as SBR), polyethylene, and polypropylene can be exemplary examples.

### (Anode Current Collector)

As the anode current collector in the anode, a strip-shaped member formed of a metal material such as Cu, Ni, and stainless steel as a forming material can be exemplary examples.

As a method for supporting the anode material mixture by the anode current collector, similar to the case of the cathode, a method in which the anode material mixture is formed by pressurization and a method in which a paste of the anode material mixture is prepared using a solvent or the like, applied and dried on the anode current collector, and the anode material mixture is compressed by pressing are exemplary examples.

### (Separator)

As the separator in the lithium secondary battery, it is possible to use, for example, a material which is made of a polyolefin resin such as polyethylene or polypropylene, a fluororesin, or a nitrogen-containing aromatic polymer and has a form such as a porous film, a non-woven fabric, or a woven fabric. In addition, the separator may be formed using two or more of these materials or the separator may be formed by laminating these materials. In addition, the separators described in JP-A-2000-030686 or US2009/0111025A1 may be used.

### (Electrolytic Solution)

The electrolytic solution in the lithium secondary battery contains an electrolyte and an organic solvent.

As the electrolyte contained in the electrolytic solution, lithium salts such as LiClO₄ and LiPF₆ are exemplary examples, and a mixture of two or more thereof may be used.

As the organic solvent contained in the electrolytic solution, for example, carbonates such as propylene carbonate, ethylene carbonate, dimethyl carbonate, diethyl carbonate, and ethyl methyl carbonate can be used.

As the organic solvent, it is preferable to use a mixture of two or more of the organic solvents. Among these, a mixed solvent containing carbonates is preferable, and a mixed solvent of a cyclic carbonate and a non-cyclic carbonate or a mixed solvent of a cyclic carbonate and an ether is more preferable.

In addition, as the electrolytic solution, it is preferable to use an electrolytic solution containing a lithium salt containing fluorine such as LiPF₆ and an organic solvent having a fluorine substituent since the safety of the lithium secondary battery to be obtained is enhanced. As the electrolyte and the organic solvent that are contained in the electrolytic solution, the electrolytes and the organic solvents described in WO2019/098384A1 or US2020/0274158A1 may be used.

### <Solid Lithium Secondary Battery>

Next, a cathode for solid lithium secondary battery, in which the CAM according to the embodiment of the present invention is used, and a solid lithium secondary battery including the cathode will be described while describing the configuration of the solid lithium secondary battery.

FIG. 2 is a schematic view showing an example of the solid lithium secondary battery according to the present embodiment. A solid lithium secondary battery 1000 shown in FIG. 2 has a laminate 100 having a cathode 110, an anode 120, and a solid electrolyte layer 130, and an exterior body 200 accommodating the laminate 100. In addition, the solid lithium secondary battery 1000 may have a bipolar structure in which the CAM and an anode active material are disposed on both sides of a current collector. As specific examples of the bipolar structure, for example, the structures described in JP-A-2004-95400 are exemplary examples. A material which configures each member will be described below.

The laminate 100 may have an external terminal 113 which is connected to a cathode current collector 112 and an external terminal 123 which is connected to an anode current collector 122. In addition, the solid lithium secondary battery 1000 may have a separator between the cathode 110 and the anode 120.

The solid lithium secondary battery 1000 further has an insulator (not shown) which insulates the laminate 100 and the exterior body 200 from each other and a sealant (not shown) which seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been carried out into a bag shape can also be used.

As the shape of the solid lithium secondary battery 1000, for example, shapes such as a coin-type, a button type, a paper-type (or a sheet-type), a cylindrical type, a square shape, and a laminate type (pouch type) can be exemplary examples.

As the example of the solid lithium secondary battery 1000, a form in which one laminate 100 is provided is shown in the drawings, but the present embodiment is not limited thereto. The solid lithium secondary battery 1000 may have a configuration in which the laminate 100 is used as a unit cell and a plurality of unit cells (laminates 100) is sealed inside the exterior body 200.

Hereinafter, each configuration will be described in order.

### (Cathode)

The cathode 110 of the present embodiment has a cathode active material layer 111 and a cathode current collector 112.

The cathode active material layer 111 contains CAM, which is one aspect of the present invention described above, and a solid electrolyte. In addition, the cathode active material layer 111 may contain a conductive material and a binder.

### (Solid Electrolyte)

As the solid electrolyte which is contained in the cathode active material layer 111 of the present embodiment, a solid electrolyte which has lithium-ion conductivity and is used in known solid lithium secondary battery can be adopted. As the solid electrolyte, an inorganic electrolyte and an organic electrolyte can be exemplary examples. As the inorganic electrolyte, an oxide-based solid electrolyte, a sulfide-based solid electrolyte, and a hydride-based solid electrolyte can be exemplary examples. As the organic electrolyte, polymer-based solid electrolytes are exemplary examples. As each electrolyte, compounds described in WO2020/208872A1, US2016/0233510A1, US2012/0251871A1, and US2018/0159169A1 are exemplary examples, and the following compounds are exemplary examples.

### (Oxide-Based Solid Electrolyte)

As the oxide-based solid electrolyte, for example, a perovskite-type oxide, a NASICON-type oxide, a LISICON-type oxide, a garnet-type oxide, and the like are exemplary examples. As specific examples of each oxide, compounds described in WO2020/208872A1, US2016/0233510A1, and US2020/0259213A1 are exemplary examples, and for example, the following compounds are exemplary examples.

As the perovskite-type oxide, Li—La—Ti-based oxides such as LiₐLa₁₋ₐTiO₃ (0<a<1), Li—La—Ta-based oxides such as Li_{b}La_{1-b}TaO₃ (0<b<1), Li—La—Nb-based oxides such as Li_{c}La_{1-c}NbO₃ (0<c<1), and the like are exemplary examples.

As the NASICON-type oxide, Li_{1+d}Al_{d}Ti₂₋ₐ(PO₄)₃ (0≤d≤1) and the like are exemplary examples. The NASICON-type oxide is an oxide represented by LiₘM¹ₙM²ₒPₚO_{q} (in the formula, M¹ is one or more elements selected from the group consisting of B, Al, Ga, In, C, Si, Ge, Sn, Sb, and Se; M² is one or more elements selected from the group consisting of Ti, Zr, Ge, In, Ga, Sn, and Al; and m, n, o, p, and q are random positive numbers).

As the LISICON-type oxide, oxides represented by Li₄M³O₄—Li₃M₄O₄ (M³ is one or more elements selected from the group consisting of Si, Ge, and Ti; and M⁴ is one or more elements selected from the group consisting of P, As, and V) and the like are exemplary examples.

As the garnet-type oxide, Li—La—Zr-based oxides such as Li₇La₃Zr₂O₁₂ (also referred to as LLZ) are exemplary examples.

The oxide-based solid electrolyte may be a crystalline material or an amorphous material.

### (Sulfide-Based Solid Electrolyte)

As the sulfide-based solid electrolyte, Li₂S—P₂S₅-based compounds, Li₂S—SiS₂-based compounds, Li₂S—GeS₂-based compounds, Li₂S—B₂S₃-based compounds, LiI—Si₂S—P₂S₅-based compounds, LiI—Li₂S—P₂O₅-based compounds, LiI—Li₃PO₄—P₂S₅-based compounds, Li₁₀GeP₂S₁₂-based compounds, and the like can be exemplary examples.

In the present specification, the expression “-based compound” that indicates the sulfide-based solid electrolyte is used as a general term for solid electrolytes mainly containing a raw material written before “-based compound” such as “Li₂S” or “P₂S₅”.

For example, the Li₂S—P₂S₅-based compounds include solid electrolytes mainly containing Li₂S and P₂S₅ and further containing a different raw material. A proportion of Li₂S which is contained in the Li₂S—P₂S₅-based compound is, for example, 50% to 90% by mass with respect to the entire Li₂S—P₂S₅-based compound. A proportion of P₂S₅ which is contained in the Li₂S—P₂S₅-based compound is, for example, 10% to 50% by mass with respect to the entire Li₂S—P₂S₅-based compound. In addition, a proportion of the different raw material which is contained in the Li₂S—P₂S₅-based compound is, for example, 0% to 30% by mass with respect to the entire Li₂S—P₂S₅-based compound. In addition, the Li₂S—P₂S₅-based compounds also include solid electrolytes containing Li₂S and P₂S₅ in different mixing ratios.

As the Li₂S—P₂S₅-based compounds, Li₂S—P₂S₅, Li₂S—P₂S₅—LiI, Li₂S—P₂S₅—LiCl, Li₂S—P₂S₅—LiBr, Li₂S—P₂S₅—LiI—LiBr, Li₂S—P₂S₅—Li₂O, Li₂S—P₂S₅—Li₂O—LiI, Li₂S—P₂S₅—ZₘSₙ (m and n are positive numbers; and Z is Ge, Zn, or Ga), and the like are exemplary examples.

As the Li₂S—SiS₂-based compounds, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—SiS₂—P₂S₅—LiCl, Li₂S—SiS₂—Li₃PO₄, Li₂S—SiS₂—Li₂SO₄, Li₂S—SiS₂—LiₓMO_{y} (x and y are positive numbers; and M is P, Si, Ge, B, Al, Ga, or In), and the like are exemplary examples.

As the Li₂S—GeS₂-based compounds, Li₂S—GeS₂, Li₂S—GeS₂—P₂S₅, and the like are exemplary examples.

The sulfide-based solid electrolyte may be a crystalline material or an amorphous material.

### (Hydride-Based Solid Electrolyte)

As the hydride-based solid electrolyte material, LiBH₄, LiBH₄-3KI, LiBH₄—PI₂, LiBH₄—P₂S₅, LiBH₄—LiNH₂, 3LiBH₄—LiI, LiNH₂, Li₂AlH₆, Li(NH₂)₂I, Li₂NH, LiGd(BH₄)₃Cl, Li₂(BH₄)(NH₂), Li₃(NH₂)I, Li₄(BH₄)(NH₂)₃, and the like can be exemplary examples.

### (Polymer-Based Solid Electrolyte)

As the polymer-based solid electrolyte, for example, organic polymer electrolytes such as polymer compounds containing one or more selected from the group consisting of a polyethylene oxide-based polymer compound, a polyorganosiloxane chain, and a polyoxyalkylene chain can be exemplary examples. In addition, it is also possible to use a so-called gel-type electrolyte in which a non-aqueous electrolytic solution is held in a polymer compound.

It is possible to use two or more kinds of the solid electrolytes in combination in a range in which the effects of the invention are not impaired.

### (Conductive Material and Binder)

As the conductive material contained in the cathode active material layer 111, the materials described in (Conductive material) above can be used. In addition, as for the proportion of the conductive material in the cathode material mixture, the proportions described in (Conductive material) above can be applied in the same manner. In addition, as the binder contained in the cathode, the materials described in (Binder) above can be used.

### (Cathode Current Collector)

As the cathode current collector 112 included in the cathode 110, the materials described in (Cathode current collector) above can be used.

As a method for supporting the cathode active material layer 111 with the cathode current collector 112, a method in which the cathode active material layer 111 is formed by pressurization on the cathode current collector 112 is an exemplary example. A cold press or a hot press can be used for the pressurization.

In addition, the cathode active material layer 111 may be supported with the cathode current collector 112 by preparing a paste of a mixture of the CAM, the solid electrolyte, the conductive material, and the binder using an organic solvent to produce a cathode material mixture, applying and drying the cathode material mixture to be obtained on at least one surface of the cathode current collector 112, and fixing the cathode material mixture by pressing.

In addition, the cathode active material layer 111 may be supported with the cathode current collector 112 by preparing a paste of a mixture of the CAM, the solid electrolyte, and the conductive material using an organic solvent to produce a cathode material mixture, applying and drying the cathode material mixture to be obtained on at least one surface of the cathode current collector 112, and calcining the cathode material mixture.

As the organic solvent which can be used for the cathode material mixture, the same organic solvent as the organic solvent which can be used in the case of preparing the paste of the cathode material mixture described in (Cathode current collector) above can be used.

As a method of applying the cathode material mixture to the cathode current collector 112, the methods described in (Cathode current collector) above are exemplary examples.

The cathode 110 can be manufactured by the method mentioned above. As a specific combination of materials used for the cathode 110, a combination of the CAM described in the present embodiment and materials described in Tables 1 to 3 is an exemplary example.

TABLE 1

| Solid electrolyte | Binder | Conductive material |
|---|---|---|
| Perovskite-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| NASICON-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| LISICON-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Garnet-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |

TABLE 2

| Solid electrolyte | Binder | Conductive material |
|---|---|---|
| Li₂S—P₂S₅-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₂S—SiS₂-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₂S—GeS₂-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₂S—B₂S₃-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |

TABLE 3

| Solid electrolyte | Binder | Conductive material |
|---|---|---|
| LiI—Si₂S—P₂S₅-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| LiI—Li₂S—P₂O₅-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| LiI—Li₃PO₄—P₂S₅-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₁₀GeP₂S₁₂-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |

### (Anode)

The anode 120 has an anode active material layer 121 and the anode current collector 122. The anode active material layer 121 contains an anode active material. In addition, the anode active material layer 121 may contain a solid electrolyte and a conductive material. As the anode active material, the anode current collector, the solid electrolyte, the conductive material, and a binder, those described above can be used.

As a method for supporting the anode active material layer 121 by the anode current collector 122, similar to the case of the cathode 110, a method in which the anode active material layer 121 is formed by pressurization, a method in which a paste-like anode material mixture containing an anode active material is applied and dried on the anode current collector 122 and the anode active material layer 121 is compressed by pressing, and a method in which a paste-like anode material mixture containing an anode active material is applied, dried and calcined on the anode current collector 122 are exemplary examples.

### (Solid Electrolyte Layer)

The solid electrolyte layer 130 has the above-described solid electrolyte.

The solid electrolyte layer 130 can be formed by depositing a solid electrolyte of an inorganic substance on the surface of the cathode active material layer 111 in the above-described cathode 110 by a sputtering method.

In addition, the solid electrolyte layer 130 can be formed by applying and drying a paste-like mixture containing a solid electrolyte on the surface of the cathode active material layer 111 in the above-described cathode 110. The solid electrolyte layer 130 may be formed by pressing the dried paste-like mixture and further pressurizing the paste-like mixture by a cold isostatic pressure method (CIP).

The laminate 100 can be manufactured by laminating the anode 120 on the solid electrolyte layer 130 provided on the cathode 110 as described above using a known method such that the anode active material layer 121 comes into contact with the surface of the solid electrolyte layer 130.

In the lithium secondary battery having the above-described configuration, since the CAM according to the present embodiment is used, it is possible to provide a lithium secondary battery capable of maintaining a discharge capacity even in a case where charging and discharging are repeated.

In addition, since the cathode having the above-described configuration has the CAM having the above-described configuration, the discharge capacity can be maintained even in a case where the charging and discharging of the lithium secondary battery are repeated.

Furthermore, since the lithium secondary battery having the above-described configuration has the above-described cathode, the lithium secondary battery is a secondary battery capable of maintaining the discharge capacity even in a case where charging and discharging are repeated.

The battery performance of the solid lithium-ion secondary battery can be evaluated by an initial charge and discharge efficiency obtained by the following method.

### [Measurement of Initial Charge and Discharge Efficiency]

### <Manufacturing of Solid Lithium-Ion Secondary Battery>

The following operation is carried out in a glove box under an argon atmosphere.

### (Production of Cathode Mixture)

1,000 g of the cathode active material obtained by the above-described method, 0.0543 g of a conductive material (Acetylene Black), and 8.6 mg of a solid electrolyte (manufactured by MSE CO., LTD., Li₆PS₅Cl) are weighed. The cathode active material, the conductive material, and the solid electrolyte are mixed in a mortar for 15 minutes to produce a cathode mixture.

### (Production of Battery Cell)

Next, 150 mg of the solid electrolyte (manufactured by MSE CO., LTD., Li₆PS₅Cl) is charged into a battery cell for an all-solid battery (HSSC-05 manufactured by Hohsen Corp.; electrode size: φ10 mm), and the cell is pressurized to a load of 29.3 kN with a uniaxial press machine to form a solid electrolyte layer.

Next, the pressure is released, and the upper punch is pulled out, and 14.4 mg of the above-described cathode mixture is put on the solid electrolyte layer molded in the cell. An SUS foil (φ10 mm×0.5 mm thick) is inserted thereon, and the upper punch is inserted again and pushed in by hand.

The all-solid battery cell is turned upside down, a punch on the side of the cathode mixture is pulled out, and a lithium metal foil (thickness: 50 μm) and an indium foil (thickness: 100 μm) punched out with a diameter of φ8.5 mm are sequentially inserted on the solid electrolyte layer as an anode.

Furthermore, an SUS foil having a diameter of φ10 mm and a thickness of 50 μm is inserted on the anode, a punch of the battery cell is inserted, and the cell is pressurized up to a load of 512 kN with a uniaxial press, and after the pressure is released, a screw of the case is tightened so that the internal restraint pressure of the cell is set to 200 MPa.

A glass desiccator in which an electrical wiring is connected inside and outside while having confidentiality is prepared, the above-described battery cell is put into the glass desiccator, each electrode of the cell and the wiring of the desiccator are connected, and the glass desiccator is sealed to produce a sulfide-based all-solid lithium-ion secondary battery. The completed sulfide-based all-solid lithium-ion secondary battery is taken out from the argon atmosphere glove box, and the following evaluation is performed.

### <Charging and Discharging Test>

Using the solid battery produced by the above-described method, a charging and discharging test is carried out under the following conditions.

### (Charging and Discharging Conditions)

Test temperature: 60° C.

### (First Charging and Discharging (Initial))

Charging maximum voltage: 3.68 V; Charging current density: 0.1 C, Cutoff current density: 0.02 C; Constant current-constant voltage charging

Discharging minimum voltage: 1.88 V; Discharging current density: 0.1 C; Constant current discharging

The initial charge and discharge efficiency obtained by the following expression is calculated using the initial charge capacity and the initial discharge capacity.

### (Initial Charge and Discharge Efficiency)

Initial charge and discharge efficiency (%)=Initial discharge capacity/Initial charge capacity×100

In a case where the initial charge and discharge efficiency (%) is 70% or more, it is evaluated that the solid battery is operating well.

As described above, although preferred examples of the embodiments according to the present invention have been described with reference to the accompanying drawings, the present invention is not limited to such examples. The variety of shapes, combinations, and the like of the individual constituent members described in the above-described examples are examples, and a variety of modifications are permitted based on design requirements and the like without departing from the gist of the present invention.

### EXAMPLES

Hereinafter, the present invention will be described with reference to Examples, but the present invention is not limited thereto.

### <Compositional Analysis of LiMO and CAM>

The composition analysis of the LiMO and CAM manufactured by the method described later was carried out by the method described in [Composition analysis]above.

### <Measurement of Dry Particle Size Distribution Measurement of LiMO and CAM>

For the LiMO and CAM, a cumulative particle size distribution curve was obtained by the method described in [Dry particle size distribution measurement]above.

<Measurement of A_{0.4} and A_{0.1}>

A_{0.4} was obtained as a value of (D₉₀−D₁₀)/D₅₀ in a case of measuring with a dispersion air pressure of 0.4 MPa.

A_{0.1} was obtained as a value of (D₉₀−D₁₀)/D₅₀ in a case of measuring with a dispersion air pressure of 0.1 MPa. The description of D₁₀, D₅₀, and D₉₀ is the same as described above.

### <Calculation of Integrated Value of Cumulative Frequency (%) of LiMO>

The integrated value of the cumulative frequency (%) of the LiMO was calculated by the method described in [Calculation of integrated value of cumulative frequency (%)] above.

### <Evaluation of Relationship Between Dispersion Air Pressure and Particle Diameter>

The absolute value of the slope of the straight line of the LiMO was calculated by the method described in [Evaluation of relationship between dispersion air pressure and particle diameter]above.

### <Measurement of Surface Presence Rate of Element A>

The surface presence rate of the element A in the coating of the CAM was measured by the method described in [Method for measuring surface presence rate of element A]above.

<Measurement of WD₅₀ and WDₘᵢₙ by Wet Particle Size Distribution Measurement>

WD₅₀ and WDₘᵢₙ of the CAM were measured by the method described in [Measurement of WD₅₀ and WDₘᵢₙ by wet particle size distribution measurement] above.

A solid lithium-ion secondary battery was manufactured by the method described in <Manufacturing of solid lithium-ion secondary battery> above.

The manufactured solid lithium secondary battery and liquid-type lithium secondary battery were subjected to a charging and discharging test according to the method described in <Charging and discharging test> above, and the battery performance was evaluated based on the value of the discharge capacity.

### Example 1

### (Production of CAM1)

### [Step of Producing LiMO]

After water was poured into a reaction vessel equipped with a stirrer and an overflow pipe, a sodium hydroxide aqueous solution was added thereto, and the liquid temperature was retained at 50° C.

A nickel sulfate aqueous solution, a cobalt sulfate aqueous solution, and a manganese sulfate aqueous solution were mixed with an atomic ratio of nickel atom, cobalt atom, and manganese atom of 0.58:0.20:0.22, thereby preparing a mixed raw material solution 1.

Next, the mixed raw material solution 1 was continuously added to the reaction vessel under stirring, using an ammonium sulfate aqueous solution as a complexing agent. A sodium hydroxide aqueous solution was added dropwise to the solution in the reaction vessel under a condition in which the pH of the solution was 12.1 (in a case where the temperature of the aqueous solution was 40° C.), thereby obtaining nickel-cobalt-manganese composite hydroxide particles.

The obtained nickel-cobalt-manganese composite hydroxide particles were washed, dewatered by a centrifugal separator, washed, dewatered, and dried at 105° C. for 20 hours to obtain a nickel-cobalt-manganese composite hydroxide 1.

The nickel-cobalt-manganese composite hydroxide 1 and a lithium hydroxide monohydrate powder were weighed and mixed in a proportion of Li/(Ni+Co+Mn)=1.03 to obtain a mixture 1.

Thereafter, the mixture 1 was primary calcined at 650° C. for 5 hours in an oxygen atmosphere.

Next, secondary calcining was performed at 850° C. for 5 hours in an oxygen atmosphere to obtain a secondary calcined product.

In the secondary calcining, the temperature rising rate was set to 134° C./hour, and the temperature decreasing rate was set to 134° C./hour.

The obtained secondary calcined product was crushed with a mass colloider-type crusher to obtain a crushed product.

The operating conditions and the mass colloider-type crusher device used were as follows.

### (Operating Conditions of Mass Colloider-Type Crusher)

Device used: MKCA6-5J manufactured by MASUKO SANGYO CO., LTD.
Rotation speed: 1,200 rpm
Interval: 100 μm
Charged amount: 3.42 kg
Recovery amount: 3.37 kg

The obtained crushed product was sieved using a turbo screener to obtain LiMO1. The operating conditions and sieving conditions of the turbo screener were as follows.

### [Operating Conditions and Sieving Conditions of Turbo Screener]

The obtained crushed product was sieved using a turbo screener (TS125×200 type, manufactured by FREUND TURBO.). The operating conditions of the turbo screener were as follows.

### (Operating Conditions of Turbo Screener)

Screen used: 45 μm mesh; Blade rotation speed: 1,800 rpm; Supply rate: 50 kg/hour

### (Evaluation of LiMO1)

In the LiMO1, A_{0.4}/A_{0.1} was 1.01, the integrated value was 1.4%, and the absolute value of the slope was 0.98. As a result of the composition analysis of the LiMO1, in a case of being represented by a compositional formula of Li[Liₓ(Ni_{(1-y-z-w)}Co_{y}Mn_{z}M_{w})₁₋ₓ]O₂, x=0.07, y=0.20, z=0.22, and w=0. The LiMO1 contained secondary particles which were an aggregate of primary particles.

### [Step of Forming Coating Layer]

### (Step of Preparing Coating Liquid)

In a dry nitrogen atmosphere, 30.8 g of ethoxy lithium (manufactured by Kojundo Chemical Lab. Co., Ltd.) was added to 412.0 g of dewatered ethanol (moisture content: 0.005% by weight or less; manufactured by Wako Pure Chemical Corporation). Next, 5.1 g of pentaethoxy niobium (manufactured by Kojundo Chemical Lab. Co., Ltd.) was dissolved therein, and mixed to obtain a coating liquid 1.

### (Coating Step)

A roll-to-roll flow coating device (MP-01, manufactured by Powrex Corp.) was used in the coating step. 600 g of the powder of the LiMO1 was subjected to a pre-treatment of drying at 120° C. for 10 hours in a vacuum atmosphere.

Thereafter, the surface of the LiMO1 was coated with the coating liquid 1 under the following conditions.
Introduced air: carbon dioxide-free air
Air supply volume: 0.23 m³/min
Air temperature: 200° C.
Spray type: two-fluid nozzle (model: MPXII-LP)
Liquid flow rate of two-fluid nozzle: 3.0 g/min
Air flow rate of two-fluid nozzle: 30 NL/min
Rotor rotation speed: 400 rpm
Air pressure of two-fluid nozzle: 0.07 MPaG
E₂: 0.05 W/g

### (Heat Treatment Step)

After coating with the coating liquid 1, the coating film was heat-treated at 200° C. for 5 hours in an oxygen atmosphere to obtain CAM1.

### [Evaluation of CAM1]

The CAM1 included a coating layer that coated at least a part of the surface of the LiMO. The coating layer had Nb.

In the CAM1, a surface presence rate of Nb was 81%, (WD₅₀−WDₘᵢₙ)/WD₅₀ was 0.50, and Z_{0.4}/Z_{0.1} was 1.02. As a result of the composition analysis of the CAM1, in a case of being represented by a compositional formula of Li[Liₐ(Ni_{(1-b-c-d)}Co_{b}Mn_{c}X_{d})₁₋ₐ]O₂, a=0.06, b=0.20, c=0.21, and d=0.02.

### Example 2

### (Production of CAM2)

### [Step of Producing LiMO]

LiMO1 was obtained by the same method as described above.

### [Step of Forming Coating Layer]

### (Step of Preparing Coating Liquid)

354.9 g of H₂O₂ water having a concentration of 30% by mass, 402.6 g of pure water, and 18.0 g of niobium oxide hydrate Nb₂O₅·3H₂O (content: 72%) were mixed with each other. Next, 35.8 g of ammonia water having a concentration of 28% by mass was added thereto, and the mixture was stirred. Furthermore, 5.1 g of LiOH H₂O was added thereto to obtain a coating liquid 2 containing a niobium peroxy complex and lithium.

### (Coating Step)

A roll-to-roll flow coating device (MP-01, manufactured by Powrex Corp.) was used in the coating step.

500 g of the powder of the LiMO1 was subjected to a pre-treatment of drying at 120° C. for 10 hours in a vacuum atmosphere.

Thereafter, the surface of the LiMO1 was coated with the coating liquid 2 under the following conditions.
Introduced air: carbon dioxide-free air
Air supply volume: 0.23 m³/min
Air temperature: 200° C.
Spray type: two-fluid nozzle (model: MPXII-LP)
Liquid flow rate of two-fluid nozzle: 2.7 g/min
Air flow rate of two-fluid nozzle: 30 NL/min
Rotor rotation speed: 400 rpm
Air pressure of two-fluid nozzle: 0.07 MPaG
E₂: 0.06 W/g

### (Heat Treatment Step)

Thereafter, the coating film was heat-treated at 200° C. for 5 hours in an oxygen atmosphere to obtain CAM2.

### [Evaluation of CAM2]

The CAM2 included a coating layer that coated at least a part of the surface of the LiMO. The coating layer had Nb.

In the CAM2, a surface presence rate of Nb was 86%, (WD₅₀−WDₘᵢₙ)/WD₅₀ was 0.50, and Z_{0.4}/Z_{0.1} was 0.88. As a result of the composition analysis of the CAM2, in a case of being represented by a compositional formula of Li[Liₐ(Ni_{(1-b-c-d)}Co_{b}Mn_{c}X_{d})₁₋ₐ]O₂, a=0.13, b=0.20, c=0.21, and d=0.02.

### Example 3

### (Production of CAM3)

### [Step of Producing LiMO]

LiMO2 was obtained by the same method as in Example 1, except that, as the nickel-cobalt-manganese composite hydroxide 1, a material having Ni/Co/Mn=60/20/20 and D₅₀ of 5 μm to 6 μm, manufactured by GUANGDONG KINLONG INDUSTRY CO., LTD., was used, Li/(Ni+Co+Mn) was set to 1.05, the temperature of the secondary calcining was set to 820° C., the temperature rising rate of the secondary calcining was set to 129° C./hour, and the temperature decreasing rate was set to 129° C./hour.

### (Evaluation of LiMO2)

In the LiMO2, A_{0.4}/A_{0.1} was 0.91, the integrated value was 0.35%, and the absolute value of the slope was 1.15. As a result of the composition analysis of the LiMO2, in a case of being represented by a compositional formula of Li[Liₓ(Ni_{(1-y-z-w)}Co_{y}Mn_{z}M_{w})₁₋ₓ]O₂, x=0.07, y=0.20, z=0.20, and w=0. The LiMO2 contained secondary particles which were an aggregate of primary particles.

### [Step of Forming Coating Layer]

### (Step of Preparing Coating Liquid)

In a dry nitrogen atmosphere, 29.2 g of ethoxy lithium (manufactured by Kojundo Chemical Lab. Co., Ltd.) was added to 393.7 g of dewatered ethanol (moisture content: 0.005% by weight or less; manufactured by Wako Pure Chemical Corporation). Next, 4.9 g of pentaethoxy niobium (manufactured by Kojundo Chemical Lab. Co., Ltd.) was dissolved therein, and mixed to obtain a coating liquid 3.

### (Coating Step)

A roll-to-roll flow coating device (MP-01, manufactured by Powrex Corp.) was used in the coating step.

600 g of the powder of the LiMO2 was subjected to a pre-treatment of drying at 120° C. for 10 hours in a vacuum atmosphere.

Thereafter, the surface of the LiMO2 was coated with the coating liquid 3 under the following conditions.
Introduced air: carbon dioxide-free air
Air supply volume: 0.23 m³/min
Air temperature: 200° C.
Spray type: two-fluid nozzle (model: MPXII-LP)
Liquid flow rate of two-fluid nozzle: 3.0 g/min
Air flow rate of two-fluid nozzle: 50 NL/min
Rotor rotation speed: 400 rpm
Air pressure of two-fluid nozzle: 0.15 MPaG
E₂: 0.14 W/g

### (Heat Treatment Step)

Thereafter, the coating film was heat-treated at 200° C. for 5 hours in an oxygen atmosphere to obtain CAM3.

### [Evaluation of CAM3]

The CAM3 included a coating layer that coated at least a part of the surface of the LiMO. The coating layer had Nb.

In the CAM3, a surface presence rate of Nb was 89%, (WD₅₀−WDₘᵢₙ)/WD₅₀ was 0.40, and Z_{0.4}/Z_{0.1} was 1.02. As a result of the composition analysis of the CAM3, in a case of being represented by a compositional formula of Li[Liₐ(Ni_{(1-b-c-d)}Co_{b}Mn_{c}X_{d})₁₋ₐ]O₂, a=0.03, b=0.20, c=0.20, and d=0.02.

### Example 4

### (Production of CAM4)

### [Step of Producing LiMO]

LiMO3 was obtained by the same method as in Example 1, except that, as the nickel-cobalt-manganese composite hydroxide 1, a material having Ni/Co/Mn=75/12.5/12.5 and D₅₀ of 3 μm, manufactured by GUANGDONG KINLONG INDUSTRY CO., LTD., was used, the temperature of the secondary calcining was set to 800° C., the temperature rising rate of the secondary calcining was set to 125° C./hour, the temperature decreasing rate was set to 125° C./hour, and the secondary calcined product was crushed in a mass colloider-type crusher and further crushed in a pin mill.

### (Pin Mill Crushing Conditions)

Device used: manufactured by MIR-SYSTEMS, LTD., AVIS100
Rotation speed: 12,000 rpm
Supply rate: 8 kg/h

### (Evaluation of LiMO3)

In the LiMO3, A_{0.4}/A_{0.1} was 0.99, the integrated value was 0.01%, and the absolute value of the slope was 0.82. As a result of the composition analysis of the LiMO3, in a case of being represented by a compositional formula of Li[Liₓ(Ni_{(1-y-z-w)}Co_{y}Mn_{z}M_{w})₁₋ₓ]O₂, x=0.03, y=0.12, z=0.13, and w=0. The LiMO3 contained secondary particles which were an aggregate of primary particles.

### [Step of Forming Coating Layer]

### (Step of Preparing Coating Liquid)

325.5 g of H₂O₂ water having a concentration of 30% by mass, 369.2 g of pure water, and 16.5 g of niobium oxide hydrate Nb₂O₅·3H₂O (content: 72%) were mixed with each other. Next, 32.9 g of ammonia water having a concentration of 28% by mass was added thereto, and the mixture was stirred. Furthermore, 4.7 g of LiOH H₂O was added thereto to obtain a coating liquid 4 containing a niobium peroxy complex and lithium.

### (Coating Step)

CAM4 was produced by the same method as in Example 2, except that the coating liquid 4 was used.

### [Evaluation of CAM4]

The CAM4 included a coating layer that coated at least a part of the surface of the LiMO. The coating layer had Nb.

In the CAM4, a surface presence rate of Nb was 89%, (WD₅₀−WDₘᵢₙ)/WD₅₀ was 0.47, and Z_{0.4}/Z_{0.1} was 0.69. As a result of the composition analysis of the CAM4, in a case of being represented by a compositional formula of Li[Lia(Ni_{(1-b-c-a)}Co_{b}Mn_{c}X_{d})₁₋ₐ]O₂, a=0.07, b=0.12, c=0.12, and d=0.03.

### Example 5

### (Production of CAM5)

### [Step of Producing LiMO]

LiMO1 was obtained by the same method as described above.

### [Step of Forming Coating Layer]

### (Step of Preparing Coating Liquid)

364.6 g of H₂O₂ water having a concentration of 30% by mass, 413.6 g of pure water, and 18.5 g of niobium oxide hydrate Nb₂O₅·3H₂O (content: 72%) were mixed with each other. Next, 36.8 g of ammonia water having a concentration of 28% by mass was added thereto, and the mixture was stirred. Furthermore, 5.3 g of LiOH H₂O was added thereto to obtain a coating liquid 5 containing a niobium peroxy complex and lithium.

### (Coating Step)

A roll-to-roll flow coating device (MP-01, manufactured by Powrex Corp.) was used in the coating step.

500 g of the powder of the LiMO1 was subjected to a pre-treatment of drying at 120° C. for 10 hours in a vacuum atmosphere.

Thereafter, the surface of the LiMO1 was coated with the coating liquid 5 under the following conditions.
Introduced air: carbon dioxide-free air
Air supply volume: 0.23 m³/min
Air temperature: 200° C.
Spray type: two-fluid nozzle (model: MPXII-LP)
Liquid flow rate of two-fluid nozzle: 2.7 g/min
Air flow rate of two-fluid nozzle: 20 NL/min
Rotor rotation speed: 400 rpm
Air pressure of two-fluid nozzle: 0.02 MPaG
E₂: 0.02 W/g

### (Heat Treatment Step)

Thereafter, the coating film was heat-treated at 200° C. for 5 hours in an oxygen atmosphere to obtain CAM5.

### [Evaluation of CAM5]

The CAM5 included a coating layer that coated at least a part of the surface of the LiMO. The coating layer had Nb.

In the CAM5, a surface presence rate of Nb was 88%, (WD₅₀−WDₘᵢₙ)/WD₅₀ was 0.51, and Z_{0.4}/Z_{0.1} was 1.01. As a result of the composition analysis of the CAM5, in a case of being represented by a compositional formula of Li[Liₐ(Ni_{(1-b-c-d)}Co_{b}Mn_{c}X_{d})₁₋ₐ]O₂, a=0.10, b=0.20, c=0.22, and d=0.03.

### Example 6

### (Production of CAM6)

### [Step of Producing LiMO]

LiMO4 was obtained by the same method as in Example 1, except that, as the nickel-cobalt-manganese composite hydroxide 1, a material having Ni/Co/Mn=60/20/20 and D₅₀ of 5 μm to 6 μm, manufactured by GUANGDONG KINLONG INDUSTRY CO., LTD., was used, the temperature of the secondary calcining was set to 840° C., the temperature rising rate of the secondary calcining was set to 132° C./hour, and the temperature decreasing rate was set to 132° C./hour.

### (Evaluation of LiMO4)

In the LiMO4, A_{0.4}/A_{0.1} was 1.14, the integrated value was 7.99%, and the absolute value of the slope was 3.87. As a result of the composition analysis of the LiMO4, in a case of being represented by a compositional formula of Li[Liₓ(Ni_{(1-y-z-w)}Co_{y}Mn_{z}M_{w})₁₋ₓ]O₂, x=0.03, y=0.20, z=0.22, and w=0. The LiMO4 contained secondary particles which were an aggregate of primary particles.

### [Step of Forming Coating Layer]

### (Step of Preparing Coating Liquid)

3.8 g of boric acid (H₃BO₃) and 9.1 g of lithium hydroxide monohydrate were added to 517.3 g of pure water, and the mixture was mixed for 2 hours to obtain a coating liquid 6.

### (Coating Step)

A roll-to-roll flow coating device (MP-01, manufactured by Powrex Corp.) was used in the coating step.

500 g of the powder of the LiMO4 was subjected to a pre-treatment of drying at 120° C. for 10 hours in a vacuum atmosphere.

Thereafter, the surface of the LiMO4 was coated with the coating liquid 6 under the following conditions.
Introduced air: carbon dioxide-free air
Air supply volume: 0.23 m³/min
Air temperature: 200° C.
Spray type: two-fluid nozzle (model: MPXII-LP)
Liquid flow rate of two-fluid nozzle: 3.0 g/min
Air flow rate of two-fluid nozzle: 30 NL/min
Rotor rotation speed: 400 rpm
Air pressure of two-fluid nozzle: 0.07 MPaG
E₂: 0.06 W/g

### (Heat Treatment Step)

Thereafter, the coating film was heat-treated at 300° C. for 5 hours in an oxygen atmosphere to obtain CAM6.

### [Evaluation of CAM6]

The CAM6 included a coating layer that coated at least a part of the surface of the LiMO. The coating layer had B.

In the CAM6, a surface presence rate of B was 81%, (WD₅₀−WDₘᵢₙ)/WD₅₀ was 0.43, and Z_{0.4}/Z_{0.1} was 1.31. As a result of the composition analysis of the CAM6, in a case of being represented by a compositional formula of Li[Liₐ(Ni_{(1-b-c-d)}Co_{b}Mn_{c}X_{d})₁₋ₐ]O₂, a=0.11, b=0.20, c=0.20, and d=0.01.

### Comparative Example 1

### (Production of CAM11)

### [Step of Producing LiMO]

A secondary calcined product in which Li/(Ni+Co+Mn) was 1.10 was obtained by a secondary calcining at 720° C. for 5 hours, in which the temperature rising rate of the secondary calcining was set to 114° C./h and the temperature decreasing rate was set to 114° C./h. The secondary calcined product was washed and stirred with pure water for 20 minutes at a slurry concentration of 40% by mass. Thereafter, LiMO5 was obtained by the same method as the LiMO1, except that the mixture was dried at 250° C. for 10 hours under a nitrogen atmosphere.

### (Evaluation of LiMO5)

In the LiMO5, A_{0.4}/A_{0.1} was 1.9, the integrated value was 28.7%, and the absolute value of the slope was 19.7. As a result of the composition analysis of the LiMO5, in a case of being represented by a compositional formula of Li[Liₓ(Ni_{(1-y-z-w)}Co_{y}Mn_{z}M_{w})₁₋ₓ]O₂, x=0.02, y=0.09, z=0, and w=0. The LiMO5 contained secondary particles which were an aggregate of primary particles.

### [Step of Forming Coating Layer]

In a dry nitrogen atmosphere, 11.9 g of ethoxy lithium (manufactured by Kojundo Chemical Lab. Co., Ltd.) was added to 159.6 g of dewatered ethanol (moisture content: 0.005% by weight or less; manufactured by Wako Pure Chemical Corporation). Next, 2.0 g of pentaethoxy niobium (manufactured by Kojundo Chemical Lab. Co., Ltd.) was dissolved therein, and mixed to obtain a coating liquid 7.

### (Coating Step)

A roll-to-roll flow coating device (MP-01, manufactured by Powrex Corp.) was used in the coating step.

500 g of the powder of the LiMO5 was subjected to a pre-treatment of drying at 120° C. for 10 hours in a vacuum atmosphere.

Thereafter, the surface of the LiMO5 was coated with the coating liquid 7 under the following conditions.
Introduced air: carbon dioxide-free air
Air supply volume: 0.23 m³/min
Air temperature: 200° C.
Spray type: two-fluid nozzle (model: MPXII-LP)
Liquid flow rate of two-fluid nozzle: 2.7 g/min
Air flow rate of two-fluid nozzle: 50 NL/min
Rotor rotation speed: 400 rpm
Air pressure of two-fluid nozzle: 0.15 MPaG
E₂: 0.14 W/g

### (Heat Treatment Step)

Thereafter, the coating film was heat-treated at 200° C. for 5 hours in an oxygen atmosphere to obtain CAM11.

### [Evaluation of CAM11]

The CAM11 included a coating layer that coated at least a part of the surface of the LiMO. The coating layer had Nb.

In the CAM11, a surface presence rate of Nb was 65%, (WD₅₀−WDₘᵢₙ)/WD₅₀ was 0.62, and Z_{0.4}/Z_{0.1} was 1.70. As a result of the composition analysis of the CAM11, in a case of being represented by a compositional formula of Li[Lia(Ni_{(1-b-c-a)}Co_{b}Mn_{c}X_{d})₁₋ₐ]O₂, a=0.03, b=0.09, c=0, and d=0.04.

### Comparative Example 2

### (Production of CAM12)

### [Step of Producing LiMO]

LiMO6 was obtained by the same method as the LiMO2, except that Li/(Ni+Co+Mn) was set to 1.06.

### (Evaluation of LiMO6)

In the LiMO6, A_{0.4}/A_{0.1} was 0.91, the integrated value was 0.35%, and the absolute value of the slope was 1.15. As a result of the composition analysis of the LiMO6, in a case of being represented by a compositional formula of Li[Liₓ(Ni_{(1-y-z-w)}Co_{y}Mn_{z}M_{w})₁₋ₓ]O₂, x=0.07, y=0.20, z=0.20, and w=0. The LiMO6 contained secondary particles which were an aggregate of primary particles.

### [Step of Forming Coating Layer]

### (Step of Preparing Coating Liquid)

261.5 g of H₂O₂ water having a concentration of 30% by mass, 296.6 g of pure water, and 13.3 g of niobium oxide hydrate Nb₂O₅·3H₂O (content: 72%) were mixed with each other. Next, 26.4 g of ammonia water having a concentration of 28% by mass was added thereto, and the mixture was stirred. Furthermore, 3.8 g of LiOH H₂O was added thereto to obtain a coating liquid 8 containing a niobium peroxy complex and lithium.

### (Coating Step)

A roll-to-roll flow coating device (MP-01, manufactured by Powrex Corp.) was used in the coating step.

500 g of the powder of the LiMO6 was subjected to a pre-treatment of drying at 120° C. for 10 hours in a vacuum atmosphere.

Thereafter, the surface of the LiMO6 was coated with the coating liquid 8 under the following conditions.
Introduced air: carbon dioxide-free air
Air supply volume: 0.23 m³/min
Air temperature: 200° C.
Spray type: two-fluid nozzle (model: MPXII-LP)
Liquid flow rate of two-fluid nozzle: 2.7 g/min
Air flow rate of two-fluid nozzle: 100 NL/min
Rotor rotation speed: 400 rpm
Air pressure of two-fluid nozzle: 0.42 MPaG
E₂: 0.59 W/g

### (Heat Treatment Step)

Thereafter, the coating film was heat-treated at 200° C. for 5 hours in an oxygen atmosphere to obtain CAM12.

### [Evaluation of CAM12]

The CAM12 included a coating layer that coated at least a part of the surface of the LiMO. The coating layer had Nb.

In the CAM12, a surface presence rate of Nb was 45%, (WD₅₀−WDₘᵢₙ)/WD₅₀ was 0.50, and Z_{0.4}/Z_{0.1} was 0.92. As a result of the composition analysis of the CAM12, in a case of being represented by a compositional formula of Li[Liₐ(Ni_{(1-b-c-a)}Co_{b}Mn_{c}X_{d})₁₋ₐ]O₂, a=0.05, b=0.20, c=0.19, and d=0.02.

### Comparative Example 3

### (Production of CAM13)

### [Step of Producing LiMO]

LiMO7 was obtained in the same manner as the LiMO6, except that Li/(Ni+Co+Mn) was set to 1.03, the temperature of the secondary calcining was set to 840° C., the temperature rising rate of the secondary calcining was set to 132° C./h, and the temperature decreasing rate was set to 132° C./h.

### (Evaluation of LiMO7)

In the LiMO7, A_{0.4}/A_{0.1} was 1.14, the integrated value was 7.99%, and the absolute value of the slope was 3.87. As a result of the composition analysis of the LiMO7, in a case of being represented by a compositional formula of Li[Liₓ(Ni_{(1-y-z-w)}Co_{y}Mn_{z}M_{w})₁₋ₓ]O₂, x=0.03, y=0.20, z=0.20, and w=0. The LiMO7 contained secondary particles which were an aggregate of primary particles.

### [Step of Forming Coating Layer]

### (Step of Preparing Coating Liquid)

77.8 g of boric acid and 155.6 g of lithium hydroxide were added to 9243.4 g of pure water, and the mixture was stirred for 2 hours to obtain a coating liquid 9.

### (Coating Step)

In the coating step, a rigid mixer (manufactured by NIPPON COKE & ENGINEERING. CO., LTD., FM20C/L) was used.

10 kg of the surface of the LiMO7 was coated with the coating liquid 9.
Introduction air: air
Air supply volume: no air
Air temperature: jacket oil temperature of 150° C.
Spray type: two-fluid nozzle (manufactured by ATOMEX, AM25S-ISVL)Liquid
flow rate of two-fluid nozzle: 26 g/min
Air flow rate of two-fluid nozzle: 14 NL/min
Mixer rotation speed: 1,050 rpm
Air pressure of two-fluid nozzle: 0.1 MPaGE₂: 0.002 W/g

### (Heat Treatment Step)

Thereafter, the coating film was heat-treated at 300° C. for 5 hours in an oxygen atmosphere to obtain CAM13.

### [Evaluation of CAM13]

The CAM13 included a coating layer that coated at least a part of the LiMO. The coating layer had B.

In the CAM13, a surface presence rate was 54%, (WD₅₀−WDₘᵢₙ)/WD₅₀ was 0.41, and Z_{0.4}/Z_{0.1} was 1.43. As a result of the composition analysis of the CAM13, in a case of being represented by a compositional formula of Li[Liₐ(Ni_{(1-b-c-d)}Co_{b}Mn_{c}X_{d})₁₋ₐ]O₂, a=0.09, b=0.20, c=0.20, and d=0.01.

### [Evaluation of Battery Performance]

The initial charge and discharge efficiency of the solid lithium-ion secondary battery using the CAM13 was 63.3%.

The production conditions, the physical properties of the LiMO and CAM of Examples 1 to 6 and Comparative Examples 1 to 3 are shown in Table 4.

TABLE 4

| | Production conditions and the like | | | | CAM | | |
|---|---|---|---|---|---|---|---|
| | | | Integrated value | | Surface | | |
| | | | of cumulative | Absolute | presence rate | | |
| | | E₂ | frequency (%) | value of | of element A | (WD₅₀ − | |
| | A_{0.4}/A_{0.1} | [W/g] | of LiMO | slope | (%) | WDₘᵢₙ)/WD₅₀ | Z_{0.4}/Z_{0.1} |
| Example 1 | 1.01 | 0.05 | 1.40 | 0.98 | 81 | 0.50 | 1.02 |
| Example 2 | 1.01 | 0.06 | 1.40 | 0.98 | 86 | 0.50 | 0.88 |
| Example 3 | 0.91 | 0.14 | 0.35 | 1.15 | 89 | 0.40 | 1.02 |
| Example 4 | 0.99 | 0.06 | 0.01 | 0.82 | 89 | 0.47 | 0.69 |
| Example 5 | 1.01 | 0.02 | 1.40 | 0.98 | 88 | 0.51 | 1.01 |
| Example 6 | 1.14 | 0.06 | 7.99 | 3.87 | 81 | 0.43 | 1.31 |
| Comparative | 1.90 | 0.14 | 28.70 | 19.70 | 65 | 0.62 | 1.70 |
| Example 1 | | | | | | | |
| Comparative | 0.91 | 0.59 | 0.35 | 1.15 | 45 | 0.50 | 0.92 |
| Example 2 | | | | | | | |
| Comparative | 1.14 | 0.002 | 7.99 | 3.87 | 54 | 0.41 | 1.43 |
| Example 3 | | | | | | | |

The results of the initial charge and discharge efficiency of Examples 2 to 6 and Comparative Example 3 are shown in Table 5.

TABLE 5

| | Initial charge and |
|---|---|
| | discharge efficiency (%) |
| Example 2 | 87.0 |
| Example 3 | 84.4 |
| Example 4 | 90.4 |
| Example 5 | 75.3 |
| Example 6 | 77.2 |
| Comparative Example 3 | 63.3 |

### REFERENCE SIGNS LIST

1: Separator
3: Anode
4: Electrode group
5: Battery can
6: Electrolytic solution
7: Top insulator
8: Sealing body
10: Lithium secondary battery
21: Cathode lead
100: Laminate
110: Cathode
111: Cathode active material layer
112: Cathode current collector
113: External terminal
120: Anode
121: Anode active material layer
122: Anode current collector
123: External terminal
130: Solid electrolyte layer
200: Exterior body
200a: Opening portion
1000: Solid lithium secondary battery

1. A method for manufacturing a cathode active material for lithium secondary battery, which includes a lithium metal composite oxide and a coating layer coating at least a part of one particle of the lithium metal composite oxide, the method comprising:
a coating step of bringing the lithium metal composite oxide into contact with a coating liquid for forming the coating layer using a coating device provided with a two-fluid nozzle,
wherein the lithium metal composite oxide satisfies the following (A),
the coating step is a step of spraying each of the coating liquid and high-pressure airflow from the two-fluid nozzle, and
the high-pressure airflow satisfies the following (B),
$${A}_{0.4} / {A}_{0.1} < 1.9 , \qquad ( A )$$
[in a volume-based cumulative particle size distribution of the lithium metal composite oxide, which is obtained by a dry particle size distribution measurement using a laser diffraction type particle size distribution analyzer, A_{0.4} is a value of (D₉₀−D₁₀)/D₅₀ in a case of measuring with a dispersion air pressure of 0.4 MPa and A_{0.1} is a value of (D₉₀−D₁₀)/D₅₀ in a case of measuring with a dispersion air pressure of 0.1 MPa,
in the cumulative particle size distribution, a particle diameter at which a cumulative proportion from a small particle side is 10%, 50%, or 90% is defined as D₁₀, D₅₀, or D₉₀], and
$$0.002 < {E}_{2} \leq 0.55 , \qquad ( B )$$
[here, E₂ (W/g) is expansion energy of the high-pressure airflow per unit mass of the lithium metal composite oxide, and expansion energy E₁ (W) generated in a case where the high-pressure airflow is released to atmospheric pressure is calculated by the following expression,
$${E}_{1} = nRT \times ln ( {P}_{1} / {P}_{2} )$$
(n=a number of moles (mol) of the high-pressure airflow, R=a gas constant, T=298.15 (K), P₁=a pressure (MPaA) of the high-pressure airflow, P₂=the atmospheric pressure (MPaA))].

2. The method for manufacturing a cathode active material for lithium secondary battery according to claim 1,
wherein the coating layer is an oxide containing an element A, and
the element A is one or more selected from the group consisting of Nb, Ta, Ti, Al, B, P, W, Zr, La, and Ge.

3. The method for manufacturing a cathode active material for lithium secondary battery according to claim 1,
wherein the lithium metal composite oxide satisfies the following formula (I),
Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Ta, Nb, and V, and −0.10≤x≤0.30, 0≤y≤0.40, 0≤z≤0.40, 0≤w ≤0.10, and y+z+w≤1 are satisfied).

4. The method for manufacturing a cathode active material for lithium secondary battery according to claim 1,
wherein the lithium metal composite oxide contains secondary particles which are an aggregate of primary particles.

5. The method for manufacturing a cathode active material for lithium secondary battery according to claim 1, further comprising, after the coating step:
a heat treatment step of performing heating at a temperature of 100° C. or higher and 500° C. or lower.

6. The method for manufacturing a cathode active material for lithium secondary battery according to claim 1,
wherein, in the lithium metal composite oxide, a cumulative frequency (%) in a range from a minimum value of a particle diameter in a particle size distribution curve (0.4) of the cumulative particle size distribution in the case of measuring with a dispersion air pressure of 0.4 MPa to a minimum value of a particle diameter in the cumulative particle size distribution obtained in a case of measuring with a dispersion air pressure of 0.1 MPa is 28% or less.

7. The method for manufacturing a cathode active material for lithium secondary battery according to claim 1,
wherein, in a scatter diagram of the lithium metal composite oxide, in which the dispersion air pressure (MPa) is used as a horizontal axis and D₁₀ (μm) is used as a vertical axis, an absolute value of a slope of a straight line, obtained by connecting a point at which the dispersion air pressure is 0.4 MPa and a point at which the dispersion air pressure is 0.1 MPa, is 19 or less.

8. The method for manufacturing a cathode active material for lithium secondary battery according to claim 1,
wherein the coating step is a step of performing the coating using a roll-to-roll flow coating device.

9. The method for manufacturing a cathode active material for lithium secondary battery according to claim 1,
wherein the cathode active material for lithium secondary battery is a cathode active material for solid lithium secondary battery.

10. A cathode active material for lithium secondary battery, comprising:
a lithium metal composite oxide; and
a coating layer which coats at least a part of one particle of the lithium metal composite oxide,
wherein the coating layer is an oxide containing an element A,
the element A is one or more selected from the group consisting of Nb, Ta, Ti, Al, B, P, W, Zr, La, and Ge, and
the following (X) to (Z) are satisfied,
(X) coverage of the lithium metal composite oxide is 70% or more,
(Y) (WD₅₀−WDₘᵢₙ)/WD₅₀≤0.6,
(in a volume-based cumulative particle size distribution curve obtained by a wet particle size distribution measurement using a laser diffraction type particle size distribution analyzer, a particle diameter (m) at which a cumulative proportion from a small particle side is 50% is defined as WD₅₀, and a minimum particle diameter (m) in the obtained cumulative particle size distribution curve is defined as WDₘᵢₙ), and
$${Z}_{0.4} / {Z}_{0.1} < 1.7 , \qquad ( Z )$$
(in a volume-based cumulative particle size distribution curve of the cathode active material for lithium secondary battery, which is obtained by a dry particle size distribution measurement using a laser diffraction type particle size distribution analyzer, Z_{0.4} is a value of (D₉₀−D₁₀)/D₅₀ in a case of measuring with a dispersion air pressure of 0.4 MPa and Z_{0.1} is a value of (D₉₀−D₁₀)/D₅₀ in a case of measuring with a dispersion air pressure of 0.1 MPa,
in the cumulative particle size distribution curve, a particle diameter at which a cumulative proportion from a small particle side is 10%, 50%, or 90% is defined as D₁₀, D₅₀, or D₉₀).

11. An electrode comprising:
the cathode active material for lithium secondary battery according to claim 10.

12. The electrode according to claim 11, further comprising:
a solid electrolyte.

13. A solid lithium secondary battery, comprising:
a cathode;
an anode; and
a solid electrolyte layer interposed between the cathode and the anode,
wherein the solid electrolyte layer contains a first solid electrolyte,
the cathode includes a cathode active material layer in contact with the solid electrolyte layer, and a current collector on which the cathode active material layer is laminated, and
the cathode active material layer contains the cathode active material for lithium secondary battery according to claim 10.

14. The solid lithium secondary battery according to claim 13,
wherein the cathode active material layer contains the cathode active material for lithium secondary battery and a second solid electrolyte.

15. The solid lithium secondary battery according to claim 14, wherein the first solid electrolyte and the second solid electrolyte are the same material.

16. The solid lithium secondary battery according to claim 13,
wherein the first solid electrolyte is a sulfide solid electrolyte.

17. The method for manufacturing a cathode active material for lithium secondary battery according to claim 2,
wherein the lithium metal composite oxide satisfies the following formula (I),
Li[Liₓ(Ni_{(1-y-z-w)}Co_{y}Mn_{z}M_{w})₁₋ₓ]O₂ (I)
(here, M is at least one element selected from the group consisting of Fe, Cu, Mg, Al, W, B, P, Mo, Zn, Sn, Zr, Ga, La, Ti, Ta, Nb, and V, and −0.10≤x≤0.30, 0≤y≤0.40, 0≤z≤0.40, 0≤w≤0.10, and y+z+w≤1 are satisfied).

18. The method for manufacturing a cathode active material for lithium secondary battery according to claim 2,
wherein the lithium metal composite oxide contains secondary particles which are an aggregate of primary particles.

19. The method for manufacturing a cathode active material for lithium secondary battery according to claim 2, further comprising, after the coating step:
a heat treatment step of performing heating at a temperature of 100° C. or higher and 500° C. or lower.

20. The method for manufacturing a cathode active material for lithium secondary battery according to claim 2,
wherein, in the lithium metal composite oxide, a cumulative frequency (%) in a range from a minimum value of a particle diameter in a particle size distribution curve (0.4) of the cumulative particle size distribution in the case of measuring with a dispersion air pressure of 0.4 MPa to a minimum value of a particle diameter in the cumulative particle size distribution obtained in a case of measuring with a dispersion air pressure of 0.1 MPa is 28% or less.

21. The method for manufacturing a cathode active material for lithium secondary battery according to claim 2,
wherein, in a scatter diagram of the lithium metal composite oxide, in which the dispersion air pressure (MPa) is used as a horizontal axis and D₁₀ (μm) is used as a vertical axis, an absolute value of a slope of a straight line, obtained by connecting a point at which the dispersion air pressure is 0.4 MPa and a point at which the dispersion air pressure is 0.1 MPa, is 19 or less.

22. The method for manufacturing a cathode active material for lithium secondary battery according to claim 2,
wherein the coating step is a step of performing the coating using a roll-to-roll flow coating device.

23. The method for manufacturing a cathode active material for lithium secondary battery according to claim 2,
wherein the cathode active material for lithium secondary battery is a cathode active material for solid lithium secondary battery.

24. The solid lithium secondary battery according to claim 14,
wherein the first solid electrolyte is a sulfide solid electrolyte.
